(19) United States
(12) Patent Application Publication
(10) Pub. No.: US 2023/0219447 A1
(43) Pub. Date: Jul. 13, 2023

(54) POWER SUPPLY SYSTEM, SERVER, AND POWER BALANCING METHOD

(71) Applicant: TOYOTA JIDOSHA KABUSHIKI KAISHA, Toyota-shi (JP)

(72) Inventors: Masato EHARA, Gotemba-shi (JP); Daiki YOKOYAMA, Gotemba-shi (JP); Yuki TAKAHASHI, Susono-shi (JP); Tomoya TAKAHASHI, Ebina-shi (JP); Tomoyuki KUBOTA, Susono-shi (JP); Sachio TOYORA, Gotemba-shi (JP); Keisuke FUKUOKA, Fujieda-shi (JP); Zidan XU, Yokohama-shi (JP); Wenfeng LIANG, Yokohama-shi (JP); Hiroki MURATA, Gotemba-shi (JP)

(73) Assignee: TOYOTA JIDOSHA KABUSHIKI KAISHA, Toyota-shi (JP)

(21) Appl. No.: 18/056,901

(22) Filed: Nov. 18, 2022

(30) Foreign Application Priority Data
Jan. 7, 2022 (JP) 2022-001808

(51) Int. Cl. B60L 53/66; B60L 53/65; B60L 53/62; B60L 53/68

(52) U.S. Cl. CPC B60L 53/66; B60L 53/65; B60L 53/62; B60L 53/68

(57) ABSTRACT

A power supply system includes power supply equipment and a vehicle management device. The power supply equipment is configured to be supplied with electric power from an external power supply and supply the electric power to a vehicle traveling in a travel lane. The vehicle management device is configured to manage vehicles configured to use the power supply equipment, and perform vehicle selection in which the vehicle management device selects a balancing vehicle from the vehicles. The vehicle management device is configured to (i) select vehicles remaining after excluding first x vehicles and last y vehicles from a vehicle group traveling in the travel lane as selection candidates and (ii) select at least one of the selection candidates as the balancing vehicle in the vehicle selection.

### CROSS-REFERENCE TO RELATED APPLICATION

This application claims priority to Japanese Patent Application No. 2022-001808 filed on Jan. 7, 2022, incorporated herein by reference in its entirety.

### BACKGROUND

### 1. Technical Field

The present disclosure relates to power supply systems, servers, and power balancing methods.

### 2. Description of Related Art

For example, Japanese Unexamined Patent Application Publication No. 2015-95983 (JP 2015-95983 A) discloses that energy management is performed through contactless charging (power receiving) or power supply by a vehicle parked on the premises of a house.

### SUMMARY

Electrified vehicles (xEVs) (e.g., battery electric vehicles) capable of storing electric power supplied from the outside of the vehicle can act as balancing power for an external power supply (e.g., balancing power for balancing supply and demand of electricity). In recent years, a technique for supplying electric power to moving xEVs has attracted attention. It is possible to perform power balancing by using this technique. Hereinafter, a lane equipped with power supply equipment is also referred to as “power supply lane.” The power supply lane is also commonly referred to as “charging lane.”

By performing power balancing of the external power supply using vehicles traveling in the power supply lane, the power supply lane can provide balancing power to the external power supply. However, such balancing adjustment power tends to be unstable. Specifically, the number of xEVs traveling in the power supply lane fluctuates. For example, the number of xEVs traveling in the power supply lane decreases when the first vehicle traveling in the power supply lane reaches the exit of the power supply lane and leaves the power supply lane. On the other hand, the number of xEVs traveling in the power supply lane increases when a new vehicle enters the power supply lane through the entrance of the power supply lane. Electric power that can be balanced in the entire power supply lane (balancing power) thus varies depending on the entry and exit status of vehicles to and from the power supply lane.

The present disclosure provides a power supply system, server, and power balancing method in which a balancing vehicle (vehicle for power balancing of an external power supply) is selected from a vehicle group traveling in a power supply lane so that the power supply lane can easily provide stable balancing power to the external power supply.

A power supply system according to a first aspect of the present disclosure includes power supply equipment and a vehicle management device. The power supply equipment is configured to be supplied with electric power from an external power supply and supply the electric power to a vehicle traveling in a travel lane. The vehicle management device is configured to manage a plurality of vehicles configured to use the power supply equipment, and perform vehicle selection in which the vehicle management device selects a balancing vehicle for power balancing of the external power supply from the vehicles. The vehicle management device is configured to select vehicles remaining after excluding first x vehicles and last y vehicles from a vehicle group traveling in the travel lane as selection candidates and select at least one of the selection candidates as the balancing vehicle in the vehicle selection. Each of the values x and y is an integer of 1 or more. Hereinafter, the above travel lane (travel lane equipped with the power supply equipment as described above) is also referred to as “power supply lane.”

According to the above configuration, of the vehicles traveling in the power supply lane, the vehicles near the first one (first x vehicles) and the vehicles near the last one (last y vehicles) are not used for power balancing of the external power supply. The last vehicle that has newly entered the power supply lane is not used for power balancing of the external power supply. Therefore, the balancing power of the power supply lane will not change even when a new vehicle enters the power supply lane and becomes the last vehicle. The first vehicle is not used for power balancing of the external power source, either. Therefore, the balancing power of the power supply lane will not change even when the first vehicle leaves the power supply lane. With the balancing vehicle (vehicle for power balancing of the external power source) selected as described above, the power supply lane can easily provide stable balancing power to the external power supply.

The balancing power means the capability in general to perform power balancing of the external power supply (frequency control, supply and demand balancing, etc.), and includes reserves. The external power supply may be a power grid (e.g., a microgrid or a large-scale power grid developed as an infrastructure). The external power supply may supply alternate current (AC) power or direct current (DC) power. The vehicle management device may be a stationary server or may be mounted on a mobile terminal. The vehicle management device may be a cloud server.

The larger the values x, y, the less likely the balancing power of the power supply lane is to fluctuate due to entering and exiting of the vehicles to and from the power supply lane. However, when the values x, y are too large, the balancing power of the power supply lane may become insufficient.

In the first aspect, the vehicle management device may be configured to determine either or both of the value x and the value y using the number of vehicles traveling in the travel lane.

When the number of vehicles traveling in the power supply lane is large, the number of vehicles entering and exiting the power supply lane per unit time tends to increase. Therefore, when the number of vehicles traveling in the power supply lane is large, the vehicle management device may increase either or both of the value x and the value y to reduce fluctuations in balancing power of the power supply lane caused by entering and exiting of the vehicles to and from the power supply lane. When the number of vehicles traveling in the power supply lane is small, the balancing power of the power supply lane tends to be insufficient. Therefore, when the number of vehicles traveling in the power supply lane is small, the vehicle management device may reduce either or both of the value x and the value y to reduce shortage of the balancing power of the power supply lane.

In the first aspect, the vehicle management device may be configured to determine either or both of the value x and the value y based on an entry and exit status of the vehicles to and from the power supply lane. By adjusting either or both of the values x and the value y according to the entry and exit status of the vehicles to and from the power supply lane, the power supply lane can easily provide stable balancing power to the external power source.

In the first aspect, the vehicle management device may be configured to determine either or both of the value x and the value y based on a type of requested power balancing when power balancing of the external power supply is requested. By adjusting either or both of the value x and the value y based on the type of requested power balancing, the power supply lane can easily provide the balancing power according to the request to the external power supply.

In the first aspect, the vehicle management device may be configured to reduce the value x when a first vehicle has left the power supply lane and increase the value y when a new vehicle has entered the travel lane such that the number of selection candidates is fixed. With this configuration, a fixed number of vehicles are selected as selection candidates. The power supply lane can therefore easily provide stable balancing power. Moreover, since the number of selection candidates does not change, the vehicle management device can easily perform vehicle management.

In the first aspect, the vehicle management device may perform update of the values x and y and the vehicle selection at a timing a first vehicle leaves the power supply lane (hereinafter also referred to as “exiting timing”) and at a timing a new vehicle enters the power supply lane (hereinafter also referred to as “entering timing”).

The selection candidates change when the first vehicle leaves the power supply lane or a new vehicle enters the power supply lane. Therefore, as the vehicle management device performs the setting of the values x, y and the vehicle selection again at least at the exiting timing and the entering timing, the power supply lane can easily provide the balancing power according to the request to the external power supply. The vehicle management device may be configured to repeatedly perform update of the values x, y and the vehicle selection during a balancing duration so that update of the value x, update of the value y, and the vehicle selection are performed at each of the exiting timing and the entering timing during the balancing duration. The balancing duration is a period during which provision of the balancing power is requested, and is commonly also referred to as “provision period.”

In the first aspect, the vehicle management device may be configured to perform the vehicle selection when the number of vehicles traveling in the power supply lane is equal to or larger than a predetermined value, and not to perform the vehicle selection when the number of vehicles traveling in the power supply lane is less than the predetermined value.

When the number of vehicles traveling in the power supply lane is not large enough, it is difficult for the power supply lane to provide stable balancing power to the external power supply. Therefore, the vehicle management device may be configured not to perform the vehicle selection when the number of vehicles traveling in the power supply lane is small. When the number of vehicles traveling in the power supply lane is small, the vehicle management device may make a predetermined arrangement so that another resource performs power balancing of the external power supply instead of the power supply lane.

In the first aspect, the vehicle management device may be configured to select the balancing vehicle from the selection candidates based on a magnitude of requested balancing power, when power balancing of the external power supply is requested. According to this configuration, the power supply lane can easily provide the requested balancing power to the external power supply. The vehicle management device may select the balancing vehicle from the selection candidates based further on at least one of the following values of the selection candidates: a state of charge (SOC), rated charge power, and rated discharge power of an energy storage device. The rated charge power is the maximum charge power of the energy storage device indicated by the manufacturer of the energy storage device. The rated discharge power is the maximum discharge power of the energy storage device indicated by the manufacturer of the energy storage device.

In the first aspect, the vehicle management device may be configured to predict the number of vehicles that are going to be traveling in the power supply lane during a predetermined period, and bid on balancing power for the predetermined period on an electricity market by using the predicted number of vehicles. According to this configuration, the vehicle management device can easily win a bid on (contract) the available balancing power predicted from the number of vehicles (specifically, the number of vehicles traveling in the power supply lane) for the day the power balancing is requested. The balancing power won by the vehicle management device is therefore likely to be provided from the power supply lane to the external power source as contracted.

In the first aspect, each of the vehicles that is selected as the balancing vehicle when charging for power balancing of the external power supply is requested may include an energy storage device configured to be charged with electric power from the power supply equipment while the vehicle is traveling in the power supply lane. The vehicle management device may be configured to determine charge power for the balancing vehicle when charging for power balancing of the external power supply is requested, and send a command to perform charging with the determined charge power to the balancing vehicle traveling in the power supply lane.

In the above configuration, the vehicle management device can easily and accurately operate the energy storage device as balancing power by controlling each balancing vehicle (specifically, controlling charging of the energy storage device) by, for example, remote control.

In the first aspect, each of the vehicles that is selected as the balancing vehicle when discharging for power balancing of the external power supply is requested may include an energy storage device configured to discharge electric power to the external power supply via the power supply equipment while the vehicle is traveling in the power supply lane. The vehicle management device may be configured to determine discharge power for the balancing vehicle when discharging for power balancing of the external power supply is requested, and send a command to perform discharging of the determined discharge power or stop charging to the balancing vehicle traveling in the power supply lane.

In the above configuration, the vehicle management device can easily and accurately operate the energy storage device as balancing power by controlling each balancing vehicle (specifically, controlling discharging of the energy storage device and stopping of charging) by, for example, remote control.

A server according to a second aspect of the present disclosure is configured to manage vehicles. Each of the vehicles managed by the server is configured to use power supply equipment. The power supply equipment is configured to be supplied with electric power from an external power supply and supply the electric power to a vehicle traveling in a travel lane. The server is configured to perform vehicle selection in which the server selects a balancing vehicle for power balancing of the external power supply from the vehicles. The server is configured to select vehicles remaining after excluding first x vehicles and last y vehicles from a vehicle group traveling in the travel lane as selection candidates and select at least one of the selection candidates as the balancing vehicle in the vehicle selection. Each of the values x and y is an integer of 1 or more.

Like the power supply system described above, the server can also select the balancing vehicle from the vehicle group traveling in the power supply lane so that the power supply lane can easily provide stable balancing power to the external power supply.

A power balancing method according to a third aspect of the present disclosure includes: determining x and y; selecting, as selection candidates, vehicles remaining after excluding first x vehicles and last y vehicles from a vehicle group traveling in a travel lane equipped with power supply equipment that is supplied with electric power from an external power supply, and selecting at least one of the selection candidates as a balancing vehicle for power balancing of the external power supply; and causing the balancing vehicle to operate for power balancing of the external power supply.

Like the power supply system described above, the power balancing method can also select the balancing vehicle from the vehicle group traveling in the power supply lane so that the power supply lane can easily provide stable balancing power to the external power supply. Power balancing of the external power supply can be performed by the selected balancing vehicle.

According to the present disclosure, it is possible to select a balancing vehicle from a vehicle group traveling in a power supply lane so that the power supply lane can easily provide stable balancing power to an external power supply.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an overall configuration of a power supply system according to an embodiment of the present disclosure;

FIG. 2 shows the configurations of a vehicle, server, and power supply equipment shown in FIG. 1;

FIG. 3 is a flowchart of a process related to power supply that is performed by the vehicle, server, and power supply equipment shown in FIG. 2;

FIG. 4 illustrates arrangement of the power supply equipment according to the embodiment of the present disclosure;

FIG. 5 is a plan view showing the overall configuration of the road shown in FIG. 4;

FIG. 6 is a flowchart of a process related to market trading that is performed by a vehicle management device shown in FIG. 1;

FIG. 7 is a flowchart of a process related to monitoring of the supply and demand balance that is performed by the vehicle management device shown in FIG. 1;

FIG. 8 is a flowchart of a power balancing method according to the embodiment of the present disclosure;

FIG. 9 is a flowchart showing details of a process related to vehicle selection shown in FIG. 8;

FIG. 10 is a flowchart showing details of a process related to power balancing shown in FIG. 8;

FIG. 11 is a flowchart showing details of a balancing canceling process shown in FIG. 8;

FIG. 12 is a flowchart of a first modification of the process shown in FIG. 9;

FIG. 13 is a flowchart of a second modification of the process shown in FIG. 9; and

FIG. 14 is a flowchart of a third modification of the process shown in FIG. 9.

### DETAILED DESCRIPTION OF EMBODIMENTS

Hereinafter, an embodiment of the present disclosure will be described in detail with reference to the drawings. The same or corresponding portions are denoted by the same signs throughout the drawings, and description thereof will not be repeated.

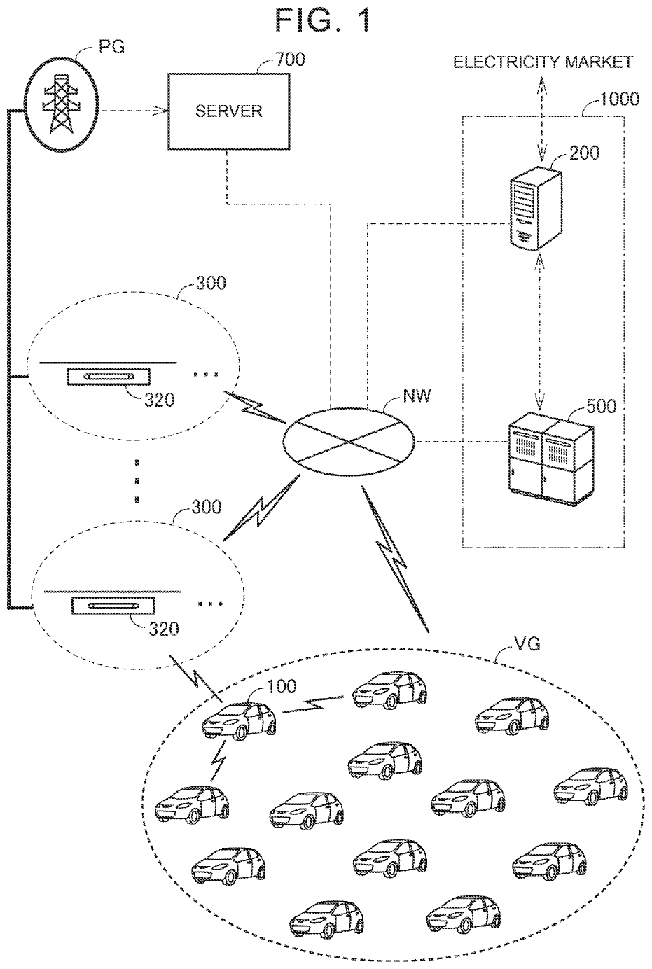

FIG. 1 shows an overall configuration of a power supply system according to an embodiment of the present disclosure. Referring to FIG. 1, the power supply system includes a vehicle management device 1000 and a plurality of pieces of power supply equipment (hereinafter, each piece of power supply equipment will be referred to as “power supply equipment 300” when not individually identified). The vehicle management device 1000 includes servers 200, 500 that can communicate with each other. The server 200 is a computer that belongs to an aggregator (hereinafter sometimes referred to as “aggregator server”).

A power grid PG is a power network formed by power transmission and distribution equipment. A plurality of power plants is connected to the power grid PG. Electric power is supplied from the power plants to the power grid PG. In the present embodiment, an electric power company maintains and manages the power grid PG (commercial power supply). The electric power company is a general power transmission and distribution operator and is also a transmission system operator (TSO). The power grid PG supplies alternate current (AC) power (e.g., three-phase AC power). A server 700 is a computer that belongs to the TSO (hereinafter sometimes referred to as “TSO server”). The server 700 may include a central load dispatching center system and a simple command system. The server 200 and the server 700 are configured to communicate with each other via a communication network NW. The power grid PG according to the present embodiment is an example of the “external power supply” according to the present disclosure.

The server 500 is configured to manage a vehicle group VG. The vehicle group VG includes a plurality of vehicles configured to use the power supply equipment 300. The server 500 is configured to periodically communicate with each vehicle in the vehicle group VG. The number of vehicles in the vehicle group VG may be 10 or more and less than 100, 100 or more and less than 500, or 500 or more. It is assumed in the present embodiment that the vehicle group VG includes about 200 vehicles. Hereinafter, each vehicle in the vehicle group VG is referred to as “vehicle 100” when not individually identified. The vehicle 100 is a vehicle managed by the vehicle management device 1000 (managed vehicle).

The power supply equipment 300 includes a power transmission coil 320 installed in a road. The vehicle 100 is configured to be supplied with power from a power supply system (more specifically, the power transmission coil 320). The vehicle 100 is configured to communicate with each of the servers 200, 500 via the communication network NW. The communication network NW is a wide area network formed by, for example, the Internet and wireless base stations. Each of the servers 200, 500 is connected to the communication network NW via, for example, a communication line. The server 200 and the server 500 may directly communicate with each other without using the communication network NW, or may communicate with each other via the communication network NW. The power supply equipment 300 is configured to wirelessly communicate with the vehicle 100. The vehicles 100 in the vehicle group VG may be configured to perform vehicle-to-vehicle communication (V2V communication) with each other. In the present embodiment, the power supply equipment 300 accesses the communication network NW by wireless communication, and communicates with the server 200 via the communication network NW. However, the present disclosure is not limited to this form, and the server 200 and the power supply equipment 300 may be directly connected by a communication line and communicate with each other without using the communication network NW.

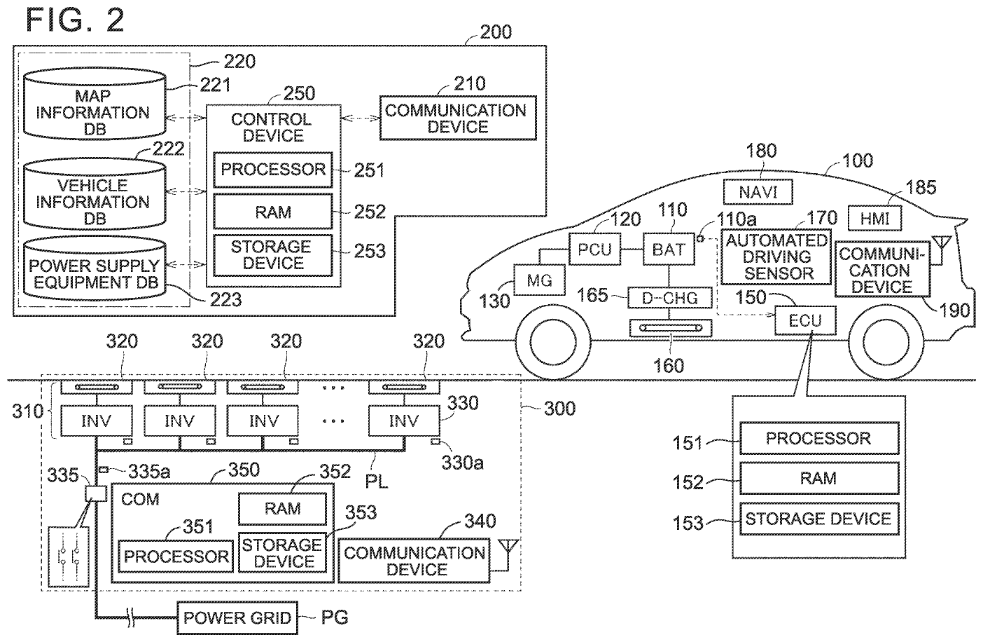

The vehicle 100 has a configuration shown in FIG. 2 described below. The vehicle 100 is an example of an object (power supply target) to which the power supply equipment 300 supplies power in the power supply system. FIG. 2 shows the configurations of the vehicle 100, the server 200, and the power supply equipment 300.

Referring to FIG. 2, the vehicle 100 includes a battery 110, a monitoring module 110a, a power control unit (PCU) 120, a motor generator (hereinafter referred to as “MG”) 130, an electronic control unit (hereinafter referred to as “ECU”) 150, a power receiving coil 160, a charger and discharger (D-CHG) 165, an automated driving sensor 170, a navigation system (hereinafter referred to as “NAVI”) 180, and a human-machine interface (HMI) 185, and a communication device 190.

The ECU 150 includes a processor 151, a random access memory (RAM) 152, and a storage device 153. The processor 151 may be a central processing unit (CPU). The RAM 152 functions as a working memory for temporarily storing data to be processed by the processor 151. The storage device 153 is configured to save stored information. The storage device 153 stores, in addition to a program, information to be used in the program (e.g., maps, mathematical formulas, and various parameters). In the present embodiment, various controls in the vehicle 100 are performed by the processor 151 executing the program stored in the storage device 153. However, the present disclosure is not limited to this, and various controls may be performed by dedicated hardware (electronic circuit).

The vehicle 100 includes a battery 110 that stores electric power for moving the vehicle 100. The vehicle 100 is configured to move using the electric power stored in the battery 110. The vehicle 100 according to the present embodiment is a battery electric vehicle (BEV) without an engine (internal combustion engine). The battery 110 can be a known energy storage device for vehicles (e.g., a liquid secondary battery, an all-solid-state secondary battery, or an assembled battery). Examples of a secondary battery for vehicles include a lithium-ion battery and a nickel metal hydride battery. The monitoring module 110a includes various sensors for detecting the state of the battery 110 (e.g., voltage, current, and temperature), and outputs the detection results to the ECU 150. The monitoring module 110a may be a battery management system (BMS) having a state of charge (SOC) estimation function, a state of health (SOH) estimation function, a cell voltage equalization function, a diagnostic function, and a communication function, in addition to the above sensor function. The ECU 150 can acquire the state of the battery 110 (e.g., temperature, current, voltage, SOC, and internal resistance) based on the output of the monitoring module 110a. The SOC indicates the remaining capacity of the energy storage device. For example, the SOC is the ratio of the available capacity to the capacity in the fully charged state and varies between 0% and 100%.

The PCU 120 is configured to include, for example, an inverter, a converter, and a relay (hereinafter referred to as “system main relay (SMR)”). The PCU 120 is controlled by the ECU 150. The MG 130 is, for example, a three-phase AC motor generator. The MG 130 is driven by the PCU 120 and is configured to rotate drive wheels of the vehicle 100. The PCU 120 drives the MG 130 using the electric power supplied from the battery 110. The MG 130 is configured to generate regenerative electric power and supplies the generated electric power to the battery 110. Any desired number of motors (MGs) for traction may be used. The number of motors (MGs) may be one, two, or three or more. The motor for traction may be an in-wheel motor. The SMR is configured to connect and disconnect the electric power path from the battery 110 to the MG 130. The SMR is closed (connected state) when the vehicle 100 is traveling.

In the present embodiment, the power receiving coil 160 is mounted in a lower part of a vehicle body (e.g., under the floor) of the vehicle 100. The position of the power receiving coil can be changed as appropriate, and the power receiving coil may be mounted near a wheel. The power receiving coil 160 is configured to perform wireless power transfer (that is, contactless power transfer) to and from the power transmission coil 320 of the power supply system. Any desired method can be used as a wireless power transfer (WPT) method, such as a magnetic field resonance method or an electromagnetic induction method. Other methods may be used. The D-CHG 165 is located in the electric circuit from the power receiving coil 160 to the battery 110. The D-CHG 165 is configured to convert the electric power supplied from the power supply system to the power receiving coil 160 to electric power suitable for charging the battery 110. The D-CHG 165 is also configured to convert the electric power of the battery 110 to electric power suitable for external discharge (discharging to the outside of the vehicle 100).

The D-CHG 165 includes, for example, an alternate current to direct current (AC-to-DC) converter circuit that performs bidirectional power conversion, and a charge and discharge relay that connects and disconnects the electric circuit from the power receiving coil 160 to the battery 110. The AC-to-DC converter circuit converts the AC power received from the power receiving coil 160 to direct current (DC) power and outputs the DC power to the battery 110. The AC-to-DC converter circuit converts the DC power received from the battery 110 to AC power and outputs the AC power to the power receiving coil 160. The D-CHG 165 may further include a direct current to direct current (DC-to-DC) converter and a filter circuit. The charge and discharge relay is controlled by the ECU 150. The charge and discharge relay is basically open (disconnected state), but is closed (connected state) when the battery 110 is charged with the electric power received by the power receiving coil 160. The charge and discharge relay is also closed (connected state) when external discharge is performed through the power receiving coil 160.

The vehicle 100 is configured to be charged while traveling. Charging of the vehicle 100 while traveling is the type of charging in which the electric power from the power supply system (more specifically, the power transmission coil 320) is input to the battery 110 via the power receiving coil 160 and the D-CHG 165 while the vehicle 100 is traveling. When charging while traveling is performed, the charge and discharge relay is closed while the vehicle 100 is traveling.

The vehicle 100 is an automated driving vehicle configured to perform automated driving. The vehicle 100 according to the present embodiment is configured to perform both manned driving (travel with an occupant(s) in the vehicle 100) and unmanned driving (travel with no occupant in the vehicle 100). Although the vehicle 100 is configured to perform unmanned autonomous driving, the vehicle 100 can also be manually driven by a user (manned driving). The vehicle 100 may be configured to travel in a platoon.

The automated driving sensor 170 is a sensor used for automated driving. The automated driving sensor 170 may be used in predetermined control when automated driving is not being performed. The automated driving sensor 170 includes a sensor that acquires information for perceiving the outside environment of the vehicle 100 (hereinafter also referred to as “outside environment sensor”), a sensor that acquires information for perceiving the in-vehicle environment of the vehicle 100 (hereinafter also referred to as “in-vehicle environment sensor”), and a sensor that acquires information on the behavior of the vehicle 100 (hereinafter also referred to as “behavior sensor”). The detection results of each sensor are output to the ECU 150.

The outside environment sensor is, for example, at least one of the following sensors: a camera, millimeter-wave radar, and light detection and ranging (LiDAR) sensor facing the outside of the vehicle. The ECU 150 can perceive the outside environment of the vehicle 100 based on the output of the outside environment sensor. The in-vehicle environment sensor is, for example, either or both of a camera and infrared sensor facing the inside of the vehicle. The ECU 150 can determine whether the vehicle 100 is manned or unmanned, based on the output of the in-vehicle environment sensor. The automated driving sensor 170 may include a seating sensor or a seatbelt sensor as the in-vehicle environment sensor. The behavior sensor is, for example, at least one of the following sensors: an Inertial Measurement Unit (IMU) and a Global Positioning System (GPS) sensor. The GPS sensor is a position sensor using GPS. The automated driving sensor 170 may include at least one of the following sensors as the behavior sensor: a vehicle speed sensor, an acceleration sensor, and a yaw rate sensor. The ECU 150 can detect or predict the position and attitude (current state or future state) of the vehicle 100 based on the output of the behavior sensor.

The NAVI 180 includes a GPS module and a storage device. The storage device stores map information. The GPS module is configured to receive signals from GPS satellites, not shown (hereinafter referred to as “GPS signals”). The NAVI 180 can identify the position of the vehicle 100 using the GPS signals. The NAVI 180 is configured to perform a route search for finding an optimal route (e.g., the shortest route) from the current position of the vehicle 100 to the destination by referring to the map information. The NAVI 180 may wirelessly communicate with a data center to update the map information. The user can set a travel plan on the NAVI 180. When a travel plan is set on the NAVI 180, the travel plan is transmitted from the vehicle 100 to the server 500. The travel plan may include at least one of the following items: a travel route, a destination, and a travel schedule (e.g., the arrival time for each set location).

The HMI 185 includes an input device and a display device. The HMI 185 may include a touch panel display. The HMI 185 may include a smart speaker that receives voice input. The HMI 185 may display various kinds of information input from the user and various kinds of information acquired from the outside of the vehicle 100 (e.g., from the server 200). The HMI 185 may display a route found by the NAVI 180.

The ECU 150 performs various controls related to traveling of the vehicle 100 (e.g., drive control, braking control, and steering control). The ECU 150 is configured to perform automated driving according to a predetermined automated driving program. The ECU 150 may perform automated driving according to the travel route and travel schedule set on the NAVI 180 by controlling an accelerator device, a brake device, and a steering device (none of which are shown) of the vehicle 100 using various kinds of information acquired by the automated driving sensor 170. The automated driving program may be sequentially updated by Over the Air (OTA).

The communication device 190 includes a long-range communication module and a short-range communication module.

The long-range communication module is a communication interface (I/F) for long-range communication. The long-range communication module includes, for example, a Data Communication Module (DCM). The long-range communication module may include a communication I/F compatible with either or both of the 5th generation mobile communication system (5G) and WiMAX (registered trademark). The long-range communication module is configured to access the communication network NW (wide area network) shown in FIG. 1. The vehicle 100 (ECU 150) is configured to access the communication network NW by the long-range communication module and wirelessly communicate with the server 200 via the communication network NW.

The short-range communication module is a communication I/F for short-range communication. The communication distance of the short-range communication is shorter than that of the long-range communication. The communication distance of the short-range communication module may be less than 200 m, or may be 1 m or more and 30 m or less. Examples of the short-range communication include communication by wireless Local Area Network (LAN), Bluetooth (registered trademark), and ZigBee (registered trademark). The short-range communication may use either or both of Radio Frequency Identification (RFID) and dedicated Short Range Communication (DSRC). The vehicle 100 (ECU 150) is configured to perform short-range wireless communication with the power supply equipment 300 (more specifically, a communication device 340 that will be described later) by the short-range communication module.

The communication device 190 may further include at least one of the following communication modules: a communication module that performs vehicle-to-vehicle (V2V) wireless communication, a communication module that performs vehicle-to-roadside infrastructure (V2I) wireless communication, and a communication module that performs wireless communication with a terminal brought into the vehicle (e.g., a smartphone or a wearable device).

The power supply equipment 300 includes a plurality of power transmission coils 320 installed in a road, power converter circuits 330 provided for each power transmission coil 320, monitoring modules 330a provided for each power converter circuit 330, a power supply relay 335, a communication device 340, a computer (hereinafter referred to as “COM”) 350, and a power supply line PL. The power supply equipment 300 may include any desired number of power transmission coils 320.

The power transmission coils 320 and the power converter circuits 330 that are installed in the road form a power supply circuit 310 that supplies power to a vehicle that is traveling on the road. Each monitoring module 330a includes a power supply sensor for detecting input and output power of a corresponding one of the power converter circuits 330. Each power converter circuit 330 is electrically connected to a corresponding one of the power transmission coils 320. Each power converter circuit 330 included in the power supply circuit 310 is electrically connected to the power supply line PL. The power supply line PL is electrically connected to the power grid PG via the power supply relay 335.

The COM 350 includes a processor 351 (e.g., CPU), a RAM 352, and a storage device 353. The storage device 353 stores, in addition to a program, information to be used in the program (e.g., maps, mathematical formulas, and various parameters). As will be described in detail later, when the power supply equipment 300 is reserved for power supply, information on the vehicle that has reserved the power supply equipment 300 for power supply (e.g., identification information) is stored in the storage device 353. In the present embodiment, various controls in the power supply equipment 300 are performed by the processor 351 executing the program stored in the storage device 353. However, the present disclosure is not limited to this, and various controls may be performed by dedicated hardware (electronic circuit).

The power converter circuit 330 includes, for example, an inverter (INV) that performs bidirectional power conversion. The power supply relay 335 is configured to connect and disconnect a power supply path. The power converter circuits 330 and the power supply relay 335 are controlled by the COM 350. The power supply relay 335 is basically open (disconnected state), but is closed (connected state) when WPT is performed by the power transmission coil 320. In WPT from the power supply equipment 300 to a vehicle (power supply lane), the power converter circuit 330 is supplied with electric power from the power supply line PL to generate electric power for WPT and output the generated electric power to the power transmission coil 320. The power converter circuit 330 reversely supplies electric power to the power grid PG by converting electric power received by the power transmission coil 320 from a vehicle (power supply lane) to the power supply equipment 300 by WPT into electric power suitable for the power supply line PL.

Each monitoring module 330a includes various sensors for detecting the state of a corresponding one of the power converter circuits 330 (e.g., a current sensor, a voltage sensor, and a temperature sensor), and outputs the detection results to the COM 350. The monitoring module 330a is configured to detect each of the output power of the power converter circuit 330 to be supplied to the vehicle on the road via the power transmission coil 320 and the input power of the power converter circuit 330 to be input from the vehicle on the road to the power converter circuit 330 via the power transmission coil 320. Specifically, each monitoring module 330a includes a current sensor and a voltage sensor for detecting the input and output power of a corresponding one of the power converter circuits 330.

The power supply line PL is provided with a watt-hour meter 335a. The watt-hour meter 335a measures a change in total value of the input power and output powers of all the power converter circuits 330 included in the power supply equipment 300. The balancing amount (AkW) of each piece of power supply equipment is measured by the watt-hour meter 335a. The watt-hour meter 335a may be a smart meter. The watt-hour meter 335a measures the electric energy every predetermined time, stores the measured electric energy, and transmits the measured electric energy to the server 200.

Like the communication device 190 described above, the communication device 340 includes a long-range communication module and a short-range communication module. The power supply equipment 300 (COM 350) is configured to access the communication network NW by the long-range communication module and wirelessly communicate with the server 200 via the communication network NW. The power supply equipment 300 (COM 350) is configured to perform short-range wireless communication with the vehicle 100 (more specifically, the communication device 190) by the short-range communication module. Therefore, when the vehicle 100 approaches the power supply equipment 300, information can be transferred between the vehicle 100 and the power supply equipment 300 by short-range wireless communication.

The server 200 includes a communication device 210, a database 220, and a control device 250. The communication device 210 is configured to communicate with each of the vehicle 100 and the power supply equipment 300 through the communication network NW. The control device 250 is configured to bidirectionally exchange information with each of the power supply equipment 300 (COM 350) and the vehicle 100 (ECU 150).

The control device 250 includes a processor 251 (e.g., CPU), a RAM 252, and a storage device 253. The storage device 253 stores, in addition to a program, information to be used in the program (e.g., maps, mathematical formulas, and various parameters). In the present embodiment, various controls in the server 200 are performed by the processor 251 executing the program stored in the storage device 253. However, the present disclosure is not limited to this, and various controls may be performed by dedicated hardware (electronic circuit).

The database 220 includes a map information database 221, a vehicle information database 222, and a power supply equipment database 223. Hereinafter, the term “database” will be referred to as “DB.”

The vehicle information DB 222 stores information on each vehicle registered in the server 200. In the present embodiment, the plurality of vehicles 100 included in the vehicle group VG (FIG. 1) is registered in the server 200, and information on the vehicles 100 is managed by the vehicle information DB 222. The vehicle information DB 222 individually manages information on each vehicle (hereinafter also referred to as “vehicle information”) in association with information identifying the vehicle (hereinafter also referred to as “vehicle identification (ID)”). For example, the vehicle information includes: information indicating the specifications of the vehicle (e.g., model, full charge capacity, rated charge power, and rated discharge power); the position of the vehicle; the driving condition (manned driving, unmanned driving, vehicle speed, etc.); a travel plan (e.g., destination); information on automated driving (e.g., target value of driving control); the state of the energy storage device (e.g., SOC); information on a power supply request (whether there is a request, requested power, etc.); information on a charging fee; and information on the performance of power balancing (e.g., incentive and penalty according to the performance of power balancing).

The power supply equipment DB 223 stores information on each piece of power supply equipment registered in the server 200. In the present embodiment, the plurality of pieces of power supply equipment 300 is registered in the server 200, and information on the pieces of power supply equipment 300 is managed by the power supply equipment DB 223. The power supply equipment DB 223 individually manages information on each piece of power supply equipment (hereinafter also referred to as “equipment information”) in association with information identifying that piece of power supply equipment (hereinafter also referred to as “equipment ID”). For example, the equipment information includes: information indicating the specifications of the power supply equipment (e.g., manufacturer, model number, power supply method, and rated output power); information on the position of the power supply equipment; information on the power supply performance (e.g., vehicle ID to which electric power is to be supplied); and maintenance information (e.g., time for inspection, time for parts replacement, and usage history).

The map information DB 221 stores map information. The map information indicates various roads in a predetermined area. The control device 250 may grasp the positions of the vehicles and the pieces of power supply equipment on the map by referring to the map information DB 221, the vehicle information DB 222, and the power supply equipment DB 223. The server 200 may further acquire traffic congestion information and weather information in each area from the outside. The traffic congestion information and the weather information may be provided on the communication network NW by, for example, a known service. The map information DB 221, the vehicle information DB 222, and the power supply equipment DB 223 are updated with the latest information periodically or at a predetermined timing. In the present embodiment, the server 500 receives predetermined vehicle information (e.g., the position of the vehicle, the driving condition, and the state of the energy storage device) from each vehicle included in the vehicle group VG. The server 200 may request the vehicle information to the server 500 and update the vehicle information DB 222 with the latest vehicle information received from the server 500, as necessary.

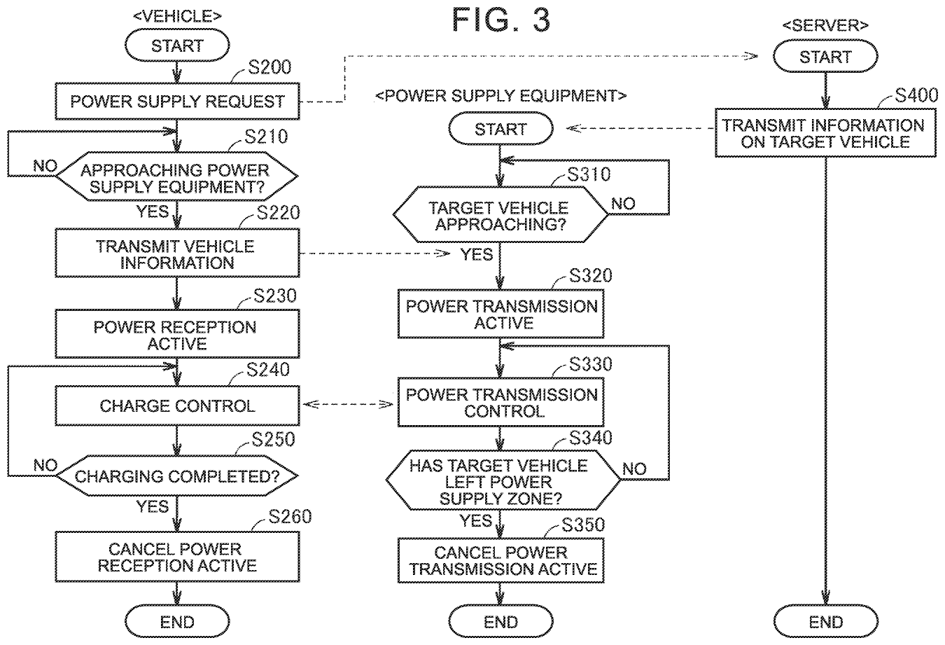

In the power supply system shown in FIG. 1, the power supply equipment 300 is configured to contactlessly supply electric power to the moving vehicle 100. FIG. 3 is a flowchart of a process that is performed by the vehicle 100, the power supply equipment 300, and the server 200 when the vehicle 100 is supplied with electric power from the power supply equipment 300. In the following description, the term “step” in the flowchart is abbreviated as “S.”

Referring to FIG. 3 together with FIGS. 1 and 2, in S200, the vehicle 100 (ECU 150) sends a power supply request to the server 200. The power supply request (S200) is fulfilled when a predetermined condition (hereinafter referred to as “power supply start condition”) is satisfied. For example, the power supply start condition may be satisfied when the user enters a predetermined input (input requesting power supply) to the HMI 185 during manned driving of the vehicle 100.

In the power supply request (S200), the ECU 150 transmits a predetermined power supply request signal to the server 200. The power supply request signal includes the identification information (vehicle ID) of the vehicle 100 and the requested power (kW). The ECU 150 may specify the power supply equipment to which the vehicle 100 requests power supply and send a power supply request. In this case, the ECU 150 transmits a power supply request signal including information specifying the power supply equipment (e.g., equipment ID and/or position) to the server 200. Hereinafter, the vehicle 100 having sent a power supply request to the server 200 will be referred to as “target vehicle.”

When the server 200 receives the power supply request signal from the target vehicle, the server 200 performs S400. In S400, the control device 250 identifies the power supply equipment to which the target vehicle requests power supply, and transmits a predetermined power supply reservation signal to the identified power supply equipment. In the case where the power supply equipment is not specified by the power supply request signal, the control device 250 may specify the power supply equipment to which the target vehicle requests power supply by using the vehicle information of the target vehicle (e.g., the position of the vehicle, a travel plan, and the SOC of the battery 110). The control device 250 may transmit a power supply reservation signal to, for example, one or more pieces of power supply equipment located on the planned travel route of the target vehicle. In this case, the position information of the power supply equipment reserved for power supply may be transmitted from the server 200 to the target vehicle, and a travel route including that power supply equipment may be set in the NAVI 180 of the target vehicle. When the travel route including the reserved power supply equipment is set in the NAVI 180, the target vehicle may start automated driving toward the reserved power supply equipment along the travel route.

The power supply reservation signal includes information on the target vehicle (e.g., vehicle ID and requested power). The control device 250 may add the vehicle information extracted from the vehicle information DB 222 based on the vehicle ID indicated by the power supply request signal to the power supply reservation signal. In the following description, the power supply equipment reserved for power supply (that is, the power supply equipment to which the server 200 has transmitted the power supply reservation signal) will be referred to as “target equipment.” In the present embodiment, the power supply equipment 300 shown in FIG. 2 is the target equipment.

When the target equipment (power supply equipment 300) receives the power supply reservation signal, the vehicle information (e.g., vehicle ID and requested power) included in the power supply reservation signal is registered in the target equipment, the target equipment performs S310. In the case where the server 200 has transmitted the power supply reservation signal to a plurality of pieces of power supply equipment 300, each target equipment (power supply equipment 300) performs a series of steps (S310 to S350) shown in FIG. 3. When one piece of power supply equipment 300 receives power supply reservation signals from a plurality of vehicles 100, the target equipment (power supply equipment 300) performs the series of steps (S310 to S350) shown in FIG. 3 for each target vehicle.

In S310, the COM 350 of the target equipment determines whether the target vehicle is approaching the communication device 340 of the target equipment installed in the road. The communication device 340 is configured to perform short-range communication with the vehicle 100. Hereinafter, the range in which the target equipment can perform short-range communication is also referred to as “power supply zone.” When the vehicle 100 is present in the power supply zone, it means that the vehicle 100 is approaching the target equipment (including the power supply circuit 310 and the communication device 340). When the COM 350 receives the vehicle ID of the target vehicle by short-range communication, the COM 350 determines in S310 that the target vehicle is approaching (YES in S310). The COM 350 repeatedly performs S310 as long as the target vehicle is not approaching (NO in S310). In the case where the approach of the target vehicle is not detected even a predetermined time after the reservation for power supply (reception of the power supply reservation signal), the COM 350 may terminate the series of steps shown in FIG. 3 due to a timeout and cancel the reservation.

When the target vehicle (vehicle 100) approaches the target equipment (YES in S210) after the transmission of the power supply request signal (S200), short-range communication between the target equipment and the target vehicle is started. In S220, the ECU 150 of the target vehicle transmits a predetermined power supply start signal to the target equipment by short-range communication. The power supply start signal includes the identification information (vehicle ID) of the target vehicle. When the short-range communication between the target equipment and the target vehicle continues, it means that the target vehicle is present in the power supply zone of the target equipment.

When the target equipment (power supply equipment 300) receives the power supply start signal, the COM 350 of the target equipment checks the vehicle ID registered by the power supply reservation signal against the vehicle ID included in the power supply start signal. When these vehicle IDs match, the COM 350 determines in S310 that the target vehicle is approaching (YES in S310), and the routine proceeds to S320. In S320, the COM 350 sets the power supply circuit 310 to a power transmission active state (state in which WPT is enabled). Electric power is thus supplied from the power converter circuit 330 to the power transmission coil 320. The power supply relay 335 is kept closed (connected state) during power transmission. WPT from the target equipment to the vehicle 100 is performed when the power receiving coil 160 of the vehicle 100 is present over the power transmission coil 320. The COM 350 may control the power supply circuit 310 and the power supply relay 335 so that power transmission is started at the timing the vehicle 100 passes the target equipment after authentication using the vehicle ID. Subsequently, the COM 350 performs power transmission control in S330. Specifically, the COM 350 controls the power converter circuit 330 (inverter) so that the electric power equivalent to the requested power of the target vehicle is supplied to the power transmission coil 320. The value of the supplied electric power detected by the monitoring module 330a during power supply is sequentially recorded together with its acquisition time in the storage device 353.

The ECU 150 of the target vehicle sets the D-CHG 165 to a power reception active state (state in which charging while traveling is enabled) in S230 after transmitting the power supply start signal (S220). As a result, the charge and discharge relay is closed (connected state), and the electric power from the target equipment (power supply equipment 300) is input to the battery 110 via the power receiving coil 160 and the D-CHG 165 of the target vehicle. Subsequently, the ECU 150 performs charge control for the battery 110 in S240. Specifically, the ECU 150 controls the D-CHG 165 so that the electric power (charge power) input to the battery 110 becomes closer to the requested power (kW). The ECU 150 also controls vehicle speed control for the target vehicle based on the requested electric energy (kWh). The lower the vehicle speed of the target vehicle, the greater the electric energy input to the battery 110. The ECU 150 can calculate the received electric power (kW) from the target equipment and the received electric energy (kWh), namely the received electric power integrated with respect to time, by using the detected values of the voltage and current of the battery 110.

In the subsequent step S250, the ECU 150 of the target vehicle determines whether charging of the battery 110 is completed. For example, when the charged energy reaches the requested electric energy or when the battery 110 is fully charged, the ECU 150 of the target vehicle determines that charging is completed. When short-range communication with the target equipment is interrupted (that is, when the target vehicle has left the power supply zone), the ECU 150 of the target vehicle determines that charging is completed. Charging of the battery 110 is performed in S240 while charging is not completed (NO in S250).

When charging is completed (YES in S250), the ECU 150 of the target vehicle cancels the power reception active state of the D-CHG 165 in S260. As a result, the D-CHG 165 is stopped, and the charge and discharge relay is opened (disconnected state). The charging process in the target vehicle is ended when S260 is performed.

The COM 350 of the target equipment determines in S340 whether the target vehicle has left the power supply zone, and performs power transmission in S330 while the target vehicle is present in the power supply zone (NO in S340). When the target vehicle has left the power supply zone (YES in S340), the COM 350 cancels the power transmission active state of the power supply circuit 310 in S350. As a result, the power converter circuit 330 (inverter) is stopped, and supply of electric power to the power transmission coil 320 is stopped. The power supply relay 335 may be opened (disconnected state) in S350, or may be kept closed (connected state) in preparation for the next vehicle. The power transmission process in the target equipment is ended after S350 is performed.

In the present embodiment, the power supply equipment 300 detects the approach of the vehicle 100 based on whether short-range communication between the vehicle 100 and the power supply equipment 300 is established. However, the method for detecting the approach of a vehicle is not limited to this method, and any desired method can be used. For example, the approach of a vehicle may be detected by a sensor installed on or around the road.

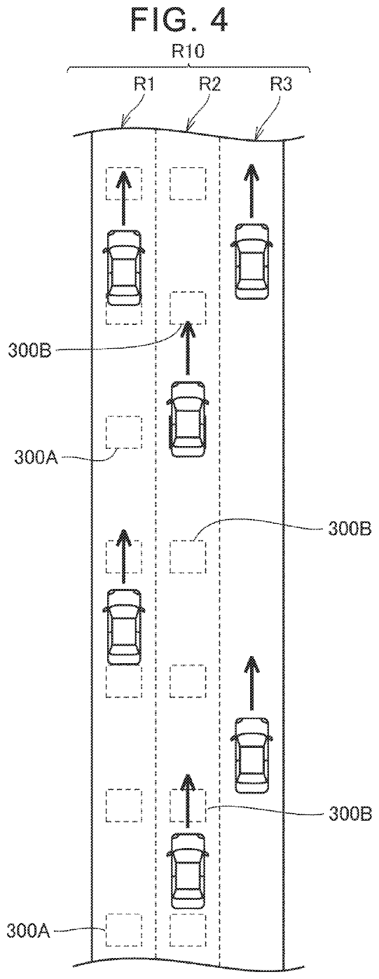

FIG. 4 illustrates arrangement of the power supply equipment according to the present embodiment. Referring to FIG. 4, the road R10 includes three travel lanes R1 to R3. Each of the travel lanes R1, R2 is a power supply lane, and the travel lane R3 is a no-power-supply lane. The travel lane R2 is located between the travel lanes R1, R3.

The power supply system according to the present embodiment includes a plurality of pieces of power supply equipment 300A and a plurality of pieces of power supply equipment 300B that are embedded in a road R10. The pieces of power supply equipment 300A are arranged at predetermined intervals in the travel lane R1. The pieces of power supply equipment 300B are arranged at predetermined intervals in the travel lane R2. The interval between the pieces of power supply equipment 300A in the travel lane R1 and the interval between the pieces of power supply equipment 300B in the travel lane R2 may be either the same or different from each other. Each of the power supply equipment 300A and the power supply equipment 300B has the same configuration as the power supply equipment 300 shown in FIG. 2. The power supply equipment 300A is configured to be supplied with electric power from the power grid PG and supply electric power to a vehicle traveling in the travel lane R1. The power supply equipment 300B is configured to be supplied with electric power from the power grid PG and supply electric power to a vehicle traveling in the travel lane R2. Each of the travel lanes R1, R2 is an example of the “travel lane” according to the present disclosure. Each of the power supply equipment 300A and the power supply equipment 300B is an example of the “power supply equipment” according to the present disclosure.

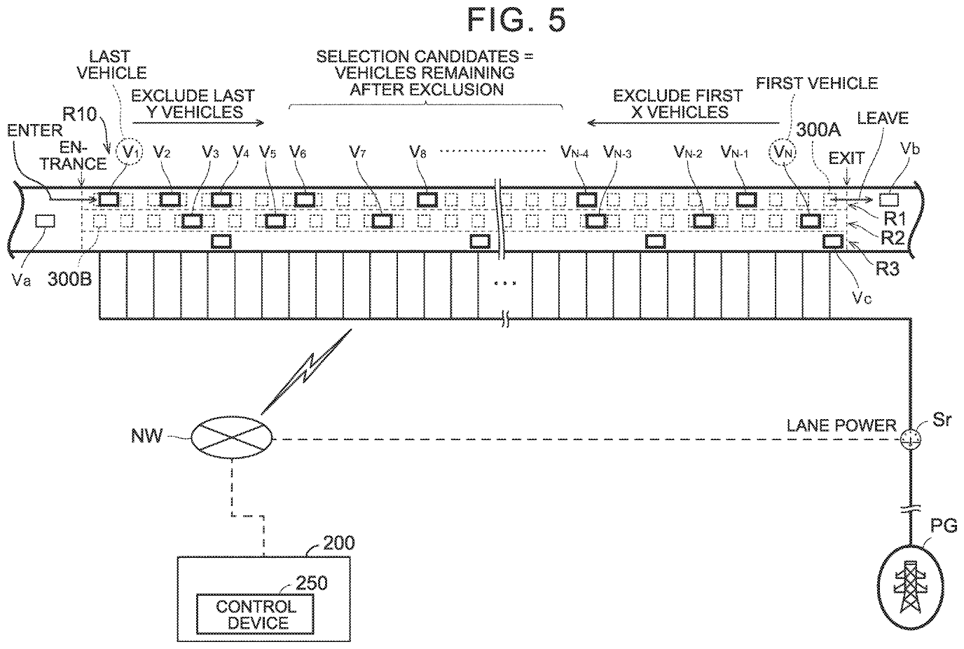

FIG. 5 is a plan view showing the overall configuration of the road R10 shown in FIG. 4. Referring to FIG. 5 together with FIGS. 1 and 2, the road R10 has an entrance and exit for the power supply lanes. The power supply lanes (travel lanes R1, R2) are provided in the area from the entrance to the exit on the road R10. In the example shown in FIG. 5, each vehicle traveling on the road R10 is a vehicle 100 (FIG. 2) included in the vehicle group VG (FIG. 1). The control device 250 of the server 200 is configured to communicate with each vehicle traveling on the road R10 and each of the pieces of power supply equipment 300A, 300B via the communication network NW. Of the vehicles 100 traveling on the road R10, the vehicles 100 traveling in the power supply lane are also referred to as “power supply lane vehicles.”

The vehicles traveling in either the travel lane R1 or R2 are power supply lane vehicles. In the example shown in FIG. 5, there are N power supply lane vehicles on the power supply lanes (travel lanes R1, R2). In FIG. 5, these power supply lane vehicles are represented by V₁, V₂, V₃, V₄, . . . , V_{N-3}, V_{N-2}, V_{N-1}, and V_{N}. The subscript after the letter “V” indicates the position of the power supply lane vehicle counted from the last power supply lane vehicle. For example, V₅ is the fifth power supply lane vehicle from the last power supply lane vehicle. A vehicle Va before the entrance of the power supply lane is not a power supply lane vehicle. A vehicle Vb having passed the exit of the power supply lane is not a power supply lane vehicle, either. A vehicle traveling in the travel lane R3 (no-power-supply lane) (e.g., a vehicle Vc) is not a power supply lane vehicle, either.

A watt-hour meter Sr is provided between the power grid PG and the power supply lanes (travel lanes R1, R2) of the road R10. The watt-hour meter Sr measures a change in total value of the input and output powers of all the pieces of power supply equipment (all the pieces of power supply equipment 300A, 300B) installed in the power supply lanes of the road R10. The watt-hour meter Sr sequentially measures and sequentially records each of the total power to be input from the power grid PG to the power supply lanes of the road R10 and the total power to be output from the power supply lanes of the road R10 to the power grid PG. The adjustment amount (AkW) by the power supply lanes of the road R10 is measured by the watt-hour meter Sr. The watt-hour meter Sr may be a smart meter. The watt-hour meter Sr measures the electric energy every predetermined time, stores the measured electric energy, and transmits the measured electric energy to the server 200. Hereinafter, the electric power detected by the watt-hour meter Sr is also referred to as “lane power.”

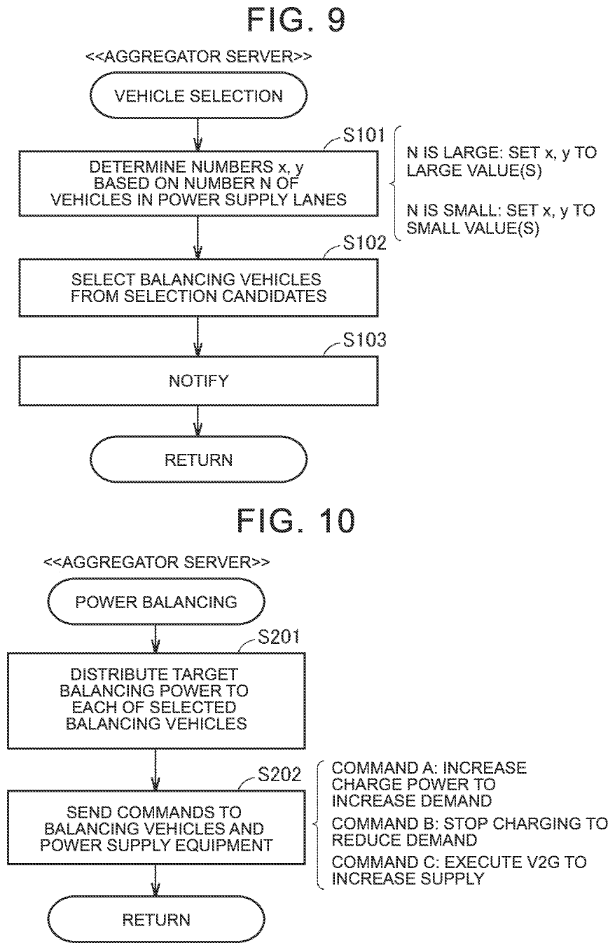

When a balancing power request is generated (that is, when power balancing of the power grid PG is requested), the control device 250 of the server 200 performs vehicle selection in which the control device 250 selects balancing vehicles for power balancing of the power grid PG (that is, vehicles that are to operate or stand by to provide the balancing power) from the vehicle group VG (FIG. 1). In the present embodiment, the control device 250 is configured to select vehicles remaining after excluding the first x vehicles and the last y vehicles from a plurality of power supply lane vehicles (vehicle group traveling in the power supply lanes) as selection candidates in the above vehicle selection. The control device 250 is also configured to select at least one of the selection candidates as balancing vehicles. The requested power balancing of the power grid PG is then performed by the selected balancing vehicles. The numbers of vehicles to be excluded, x and y, are integers of 1 or more, and are determined by the process shown in FIG. 9 that will be described later.

In the present embodiment, a balancing power request is generated when the control device 250 wins a bid for the balancing power of the power grid PG on the electricity market. Electricity is traded as products on the electricity market. Each product is bought and sold by, for example, bidding. The balancing power of the power grid PG is also traded on the electricity market. The balancing power gives the power grid PG flexibility (ability to change production or consumption of electric power in response to power fluctuations). Products are traded on a period-by-period basis on the electricity market. A “period” is one of frames of unit time into which one day is divided (hereinafter the “period” will be referred to as “frame”). In the present embodiment, electricity is traded for 48 frames of 30 minutes into which one day is divided. The market closing time for each frame is called “gate close (GC).” In the present embodiment, GC is an hour before the start time of the frame.

An aggregator conducts electronic commerce using the server 200. The server 200 trades the balancing power on the electricity market. Accounting for market trading is managed by the server 200. When the server 200 wins a bid for the balancing power on the electricity market, the server 200 generates a balancing power request corresponding to the won balancing power.

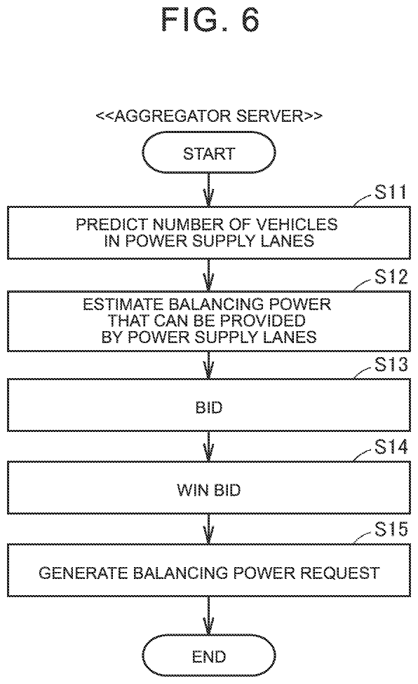

FIG. 6 is a flowchart of a process related to market trading that is performed by the server 200. The process shown in this flowchart is performed when a predetermined condition is satisfied. The predetermined condition may be satisfied either at a predetermined time or periodically. The predetermined condition may be satisfied when the server 200 receives a bid instruction from the user. The server 200 may determine the timing suitable for bidding based on at least one of the following pieces of information: market price, weather information (including weather forecast information), and demand history of the vehicle group VG, and perform the process of FIG. 6 at the timing suitable for bidding. The electricity market is, for example, a spot market (day-ahead market). However, the present disclosure is not limited to this, and the electricity market may be an hour-ahead market (intraday market), a balancing market, or a capacity market.

Referring to FIG. 6 together with FIGS. 1, 2, and 5, in S11, the control device 250 of the server 200 predicts the number of vehicles 100 that will be traveling in the power supply lanes (travel lanes R1, R2) of the road R10 during a predetermined period (e.g., a frame corresponding to each product). Hereinafter, the predetermined period is also referred to as “target trading period.” The control device 250 may predict this number of vehicles by using the vehicle information (e.g., travel plans) managed by the vehicle information DB 222. The control device 250 may predict this number of vehicles based on the level of traffic congestion in the power supply lanes predicted from traffic information. The server 200 may acquire traffic information through Vehicle Information and Communication System (VICS) (registered trademark).

In the subsequent step S12, the control device 250 predicts the balancing power that can be provided by the power supply lanes (travel lanes R1, R2) of the road R10 during the target trading period by using the number of vehicles 100 predicted in S11. The larger the number of vehicles 100 predicted in S11, the larger the balancing power (upper limit value of the balancing power) that can be provided by the power supply lanes of the road R10 during the target trading period. The control device 250 may predict this balancing power by further using information on the charge and discharge specifications (e.g., at least one of the following values: full charge capacity, rated charge power, and rated discharge power) of each vehicle 100 predicted to be present in the power supply lanes of the road R10 during the target trading period.

In the following S13, the control device 250 selects a product for trading using the balancing power predicted in S12, and bids on the selected product. In S14, the control device 250 receives a notification from a market manager that the control device 250 has won the bid product (balancing power). Thereafter, when the start time of the won balancing force (start time of the target trading period) comes, the control device 250 generates a balancing power request corresponding to the won balancing power in S15. As described above, the server 200 is configured to predict the number of vehicles that will be traveling in the power supply lanes during a predetermined period (S11) and bid on the balancing power for the predetermined period on the electricity market by using the predicted number of vehicles (S13).

When the balancing power request is generated in S15, the server 200 (aggregator) is requested to provide the balancing power during the target trading period. That is, the target trading period is a balancing duration (period during which provision of the balancing power is requested). The aggregator (winning bidder) who has won the bid on the balancing power performs power balancing within the range of the won amount (AkW contract amount) with respect to a reference value (kW). The won amount may be positive (upward balancing power) or negative (downward balancing power). The winning bidder notifies the market manager of the reference value by GC (an hour before the start time of the won frame). The market manager is notified in advance of the power supply lanes of the road R10 as resources (e.g., a list pattern) to be used for power balancing. The server 200 performs power balancing using the power supply lanes of the road R10 in one or more won frames (balancing durations). The server 200 controls the lane power (electric power detected by the watt-hour meter Sr) according to, for example, a command from the server 700 (TSO server). In the case where an output command value is changed during the balancing duration, the server 200 changes the output of the power supply lanes (lane power) to that value within the response time of the product requirement. In the case where the output command value remains the same during the balancing duration, the server 200 maintains the output of the power supply lanes (lane power) according to that command for at least the duration of the product requirement. After all the won frames end, the server 200 transmits data on the performance of power balancing for these frames to the server 700.

The aggregator is responsible for achieving balancing of the power grid PG, in addition to the market trading described above. The aggregator is a balance responsible party (BRP). The planned value power balancing system is used in the present embodiment. The aggregator submits a planned value for each frame to a predetermined institution in advance. In the present embodiment, the length of the frame (unit time) is 30 minutes. The predetermined institution may be Organization for Cross-regional Coordination of Transmission Operators, JAPAN (OCCTO). The deadline for changing a planned value (deadline for submitting a planned supply and demand value) in the planned value power balancing system is GC (an hour before the frame), and the planned value can no longer be changed after GC. An imbalance (discrepancy from the planned value) regarding balancing is evaluated for each frame. The aggregator that caused an imbalance is obliged to pay an imbalance charge (penalty).

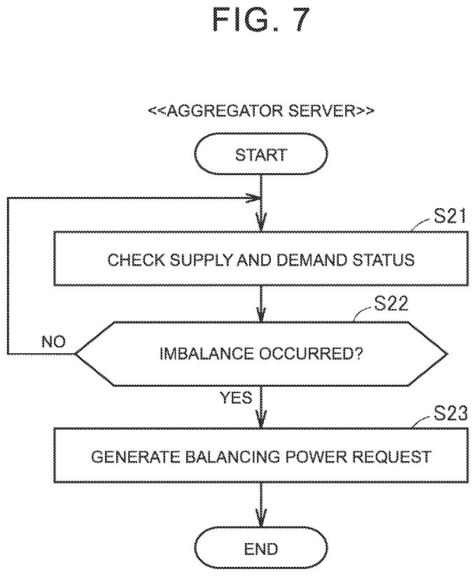

The aggregator monitors the supply and demand balance (balancing) of the power grid PG by using the server 200. FIG. 7 is a flowchart of a process related to monitoring of the supply and demand balance that is performed by the server 200. The process shown in this flowchart may be started at the start time of a predetermined frame (frame to be monitored).

Referring to FIG. 7 together with FIGS. 1, 2, and 5, in S21, the control device 250 of the server 200 acquires actual supply and demand in the relationship between the aggregator (more specifically, each resource managed by the aggregator) and the power grid PG. The actual supply and demand may include either or both of the electric energy supplied from the power grid PG to the aggregator and used by the aggregator (electricity demand) and the electric energy supplied from the aggregator to the power grid PG (electricity supply). The actual supply and demand is detected by, for example, a sensor in each resource (including the power supply lanes of the road R10) managed by the aggregator.

In the subsequent step S22, the control device 250 determines whether an imbalance regarding balancing of the power grid PG is greater than a predetermined allowable range in the monitored frame. While the imbalance is within the allowable range (NO in S22), steps S21, S22 are repeated. When the imbalance becomes greater than the allowable range (YES in S22), the control device 250 generates a balancing power request for eliminating the imbalance in S23.

An imbalance regarding balancing is, for example, the difference between the planned supply and demand value and the actual supply and demand value. For example, an imbalance regarding balancing occurs when the demand forecast is wrong and the actual value of demand (power consumption) becomes larger than the planned value. An imbalance regarding balancing also occurs when the power generation forecast (e.g., the forecast of electric power generated by photovoltaic power generation or wind power generation) is wrong and the actual value of supply (generated power) becomes larger than the planned value.

When a balancing power request is generated in S23, the server 200 (aggregator) is requested to provide the balancing power in the monitored frame. That is, the monitored frame (30 minutes) is a balancing duration. The server 200 balances the actual supply and demand using the power supply lanes of the road R10 so that the imbalance with respect to the planned value (kWh) in the monitored frame becomes small enough.

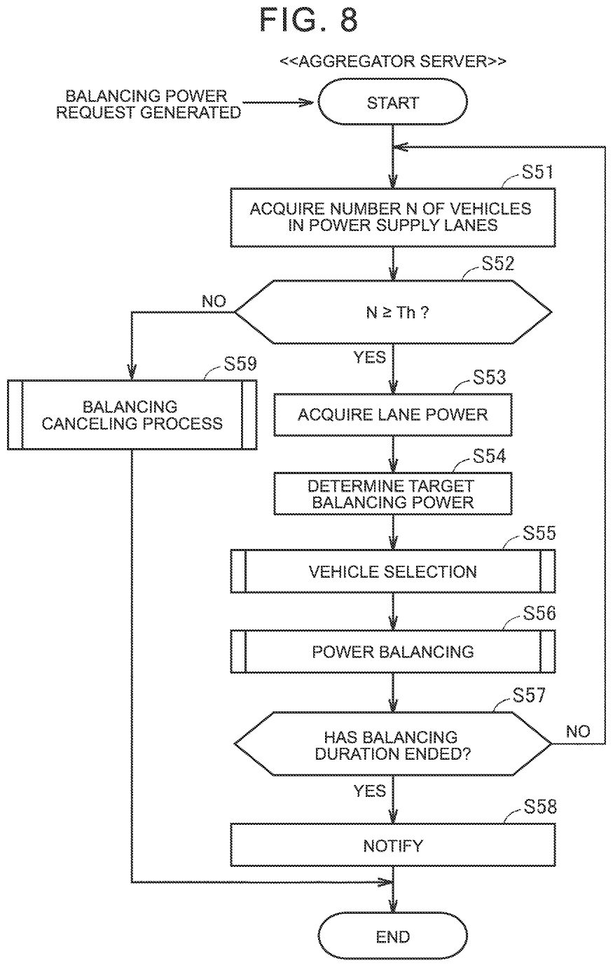

When a balancing power request is generated in S15 of FIG. 6 or S23 of FIG. 7, the server 200 starts a series of steps shown in FIG. 8 described below. FIG. 8 is a flowchart of a power balancing method according to the present embodiment.

Referring to FIG. 8 together with FIGS. 1, 2, and 5, in S51, the control device 250 of the server 200 acquires the number of vehicles 100 traveling in the power supply lanes (travel lanes R1, R2) of the road R10 (hereinafter this number of vehicles 100 will be referred to as “number N”).

The control device 250 may detect the number N using the vehicle information (e.g., the positions of the vehicles) managed by the vehicle information DB 222. The control device 250 can acquire the latest data from the server 500. The control device 250 may detect the number N using the information acquired from the power supply equipment 300. For example, each piece of power supply equipment (power supply equipment 300A, 300B) installed in the power supply lanes of the road R10 may sequentially transmit the vehicle ID of each vehicle having passed through that power supply equipment to the server 200 together with the equipment ID of that power supply equipment.

The control device 250 may detect the number N using the information acquired from the road R10 or the vehicles 100 traveling on the road R10. For example, the control device 250 may detect the number N using a sensor or camera (e.g., an N-system (automatic license plate recognition system) or a traffic counter) mounted on the road R10. Alternatively, a first communication device (not shown) mounted near the entrance of the power supply lanes of the road R10 may wirelessly communicate with a vehicle having newly entered the power supply lane. The first communication device may notify this vehicle that the vehicle has entered the power supply lane, receive the vehicle ID from this vehicle (vehicle ID of the last vehicle), and transmit the vehicle ID of the last vehicle to the server 200. A second communication device (not shown) mounted near the exit of the power supply lanes of the road R10 may wirelessly communicate with a vehicle having left the power supply lane. The second communication device may notify this vehicle (exiting vehicle that had been the first vehicle until just before), receive the vehicle ID from this vehicle (vehicle ID of the exiting vehicle), and transmit the vehicle ID of the exiting vehicle to the server 200. The vehicles 100 on the power supply lanes of the road R10 may exchange information (e.g., vehicle ID and vehicle position) with each other by vehicle-to-vehicle communication (V₂V communication). Information indicating the surroundings of each vehicle 100 on the power supply lanes may be transmitted from each vehicle 100 to the server 200.

In the subsequent step S52, the control device 250 determines whether the number N acquired in S51 is equal to or larger than a predetermined value (hereinafter referred to as “Th”). Th is set to the minimum number of vehicles required for the power supply lanes (travel lanes R1, R2) of the road R10 to perform requested power balancing (specifically, the minimum number of power supply lane vehicles in consideration of the minimum numbers of vehicles, x and y, that will be described below). The control device 250 may set Th according to the magnitude of the requested balancing power, based on the generated balancing power request. The control device 250 may increase Th as the requested balancing power increases. FIG. 5 shows an example in which the number N is 10 or more. However, the number N changes from moment to moment according to the entry and exit status of the vehicles 100 to and from the power supply lanes. The number N may be less than 10 depending on the condition of the power supply lanes.

When the number N is Th or more (YES in S52), the control device 250 acquires the lane power (electric power detected by the watt-hour meter Sr) in S53. In the subsequent step S54, the control device 250 determines target balancing power based on the requested balancing power (magnitude of the balancing power requested by the generated balancing power request). For a balancing power request generated due to a successful bid on the electricity market, the control device 250 may determine target balancing power based on, for example, the requested balancing power indicated by the command from the server 700 (TSO server) and the lane power detected by the watt-hour meter Sr. For a balancing power request generated due to an imbalance regarding balancing, the control device 250 may determine target balancing power based on, for example, the planned value, the actual supply and demand, and the lane power. Subsequently, the control device 250 performs vehicle selection in S55. FIG. 9 is a flowchart showing details of the vehicle selection.

Referring to FIG. 9 together with FIGS. 1, 2, and 5, in S101, the control device 250 determines the numbers of vehicles to be excluded, x and y (hereinafter referred to as “numbers x and y”), by using the number N (the number of vehicles 100 traveling in the power supply lanes) and the target balancing power. The control device 250 increases the numbers x, y as the number N increases. The control device 250 reduces the numbers x, y as the target balancing power increases. A factor that associates each of the number N and the target balancing power with the numbers x, y may be set, and the degree of influence on the numbers x, y may be adjusted (weighted) by the factor. In the present embodiment, x and y are the same value. However, the present disclosure is not limited to this, and x and y may be different values from each other. In the present embodiment, each of x and y is set to a predetermined minimum value or more. The minimum value for each of x and y is 1. However, the present disclosure is not limited to this, and the minimum value for each of x and y can be independently set to a desired integer of 1 or more, and may be set to an integer of 2 or more.

In the subsequent step S102, the control device 250 selects vehicles 100 remaining after excluding the first x vehicles 100 and the last y vehicles 100 from a plurality of vehicles 100 (vehicle group) traveling in the power supply lanes of the road R10 as selection candidates. For example, when both x and y are 1, the vehicles (V₂ to V_{N-1}) remaining after excluding the vehicles V₁ and V_{N} from the N power supply lane vehicles (V₁ to V_{N}) are selection candidates. When both x and y are 5, the vehicles (V₆ to V_{N-5}) remaining after excluding the vehicles V₁ to V₅ and V_{N-4} to V_{N} from the N power supply lane vehicles (V₁ to V_{N}) are selection candidates. The control device 250 then selects at least one of the selection candidates as balancing vehicles. In the present embodiment, the control device 250 selects balancing vehicles from the selection candidates based on the target balancing power (specifically, the target balancing power determined based on the magnitude of the requested balancing power). Specifically, the control device 250 excludes vehicles that cannot deal with the target balancing power (requested balancing power) from the selection candidates based on the vehicle information of each vehicle included in the selection candidates (for example, the full charge capacity, SOC, rated charge power, and rated discharge power of the battery 110), and selects the remaining vehicles as balancing vehicles. However, the present disclosure is not limited to this, and the control device 250 may select all of the selection candidates as balancing vehicles.

In the subsequent step S103, the control device 250 notifies a user terminal of each selected balancing vehicle of the start of power balancing. The user terminal may be a terminal mounted on the vehicle or a mobile terminal carried by the vehicle user. In the present embodiment, the process shown in FIG. 3 will not be performed on each of the selected balancing vehicles out of the N power supply lane vehicles. Instead, charge and discharge control will be performed on each of the selected balancing vehicles by the process shown in FIG. 10 that will be described later. On the other hand, the power supply lane vehicles not selected as the balancing vehicles can be supplied with electric power from the power supply lanes (travel lanes R1, R2) of the road R10 by the process shown in FIG. 3. However, the present disclosure is not limited to this, and the server 200 (control device 250) may prohibit charging using the power supply lanes (travel lanes R1, R2) of the road R10 when discharge for power balancing of the power grid PG is requested.

When S103 is performed, the series of steps shown in FIG. 9 ends, and the routine proceeds to S56 in FIG. 8. In S56, the control device 250 performs power balancing of the power grid PG. FIG. 10 is a flowchart showing details of power balancing.

Referring to FIG. 10 together with FIGS. 1, 2, and 5, in S201, the control device 250 distributes the target balancing power to each balancing vehicle. For example, when the target balancing power is the balancing power for charging (that is, when charging for power balancing is requested), the control device 250 determines the charge power for each balancing vehicle. The control device 250 may determine the charge power for each balancing vehicle based on the vehicle information of each balancing vehicle (e.g., the SOC and rated charge power of the battery 110). The control device 250 may allocate high charge power to the balancing vehicles with high rated charge power and the balancing vehicles with low SOC. When the target balancing power is the balancing power for discharging (that is, when discharging for power balancing is requested), the control device 250 determines the discharge power for each balancing vehicle. The discharge power allocated to the balancing vehicles may be 0 kW (charging is stopped). The control device 250 may determine the discharge power for each balancing vehicle based on the vehicle information of each balancing vehicle (e.g., the SOC and rated discharge power of the battery 110). The control device 250 may allocate high discharge power to the balancing vehicles with high rated discharge power and the balancing vehicles with high SOC.

In the subsequent step S202, the control device 250 sends a command to operate each balancing vehicle according to the balancing power (charge power or discharge power) determined in S201 (hereinafter this command will be referred to as “balancing command”) to each balancing vehicle traveling in the power supply lanes (travel lanes R1, R2) of the road R10 and each piece of power supply equipment (power supply equipment 300A, 300B) installed in the power supply lanes of the road R10. The balancing commands together with the vehicle IDs of the balancing vehicles are transmitted to the power supply equipment 300A and the power supply equipment 300B.

Power balancing using WPT is performed between each balancing vehicle and the power supply equipment 300 (power supply equipment 300A or 300B) in a manner according to the process of FIG. 3. In S240, each balancing vehicle performs charge and discharge control according to the balancing command from the server 200 (control device 250). When the power supply equipment 300 receives the vehicle ID from the balancing vehicle by short-range communication (YES in S310), the power supply equipment 300 performs charge and discharge control according to the balancing command corresponding to the vehicle ID of this balancing vehicle in S330. Power balancing of the power grid PG is performed as each balancing vehicle traveling in the power feeding lanes of the road R10 performs charge control, discharge control, or charge stop control according to the balancing command from the server 200. The control device 250 can increase the demand of the power grid PG by sending a command to increase the charge power of the battery 110 in the balancing vehicle (command A) to the balancing vehicles. The control device 250 can reduce an increase in demand of the power grid PG by sending a command to prohibit charging of the battery 110 in the balancing vehicle (command B) to the balancing vehicles. The control device 250 can increase supply of the power grid PG by sending a command to execute vehicle-to-grid (V2G) from the balancing vehicle to the power grid PG (command C) to the balancing vehicles.

When charging is requested by the generated balancing power request, the control device 250 sends a command to perform charging with the charge power determined in S201 to each balancing vehicle. When discharging is requested by the generated balancing power request, the control device 250 sends a command to perform discharging with the discharge power determined in S201 or to stop charging to each balancing vehicle. The lane power is thus controlled according to the generated balancing power request. After step S202 is performed, the series of steps shown in FIG. 10 ends, and the routine proceeds to S57 in FIG. 8.

Referring to FIG. 8 together with FIGS. 1, 2, and 5, in S57, the control device 250 determines whether the balancing duration of the generated balancing power request has ended. When it is still within the balancing duration (NO in S57), the routine returns to S51, and power balancing of the power grid PG by the power supply lanes of the road R10 is performed in the steps described above (S51 to S56). When the balancing duration has elapsed (YES in S57), step S58 is performed. The series of steps shown in FIG. 8 then ends. In S58, the control device 250 notifies the user terminal of each balancing vehicle of the end of the power balancing. The user terminal may be a terminal mounted on the vehicle or a mobile terminal carried by the vehicle user.

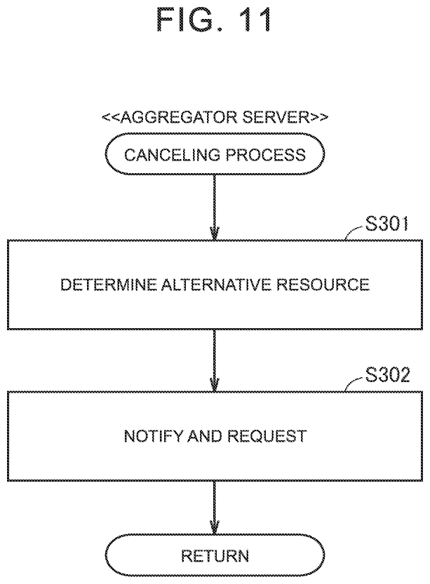

When the number N is less than Th (NO in S52), the control device 250 determines that the requested power balancing cannot be performed by the power supply lanes of the road R10. In this case, the routine proceeds to S59. In S59, the control device 250 performs a predetermined balancing canceling process. FIG. 11 is a flowchart showing details of the balancing canceling process.

Referring to FIG. 11 together with FIGS. 1, 2, and 5, in S301, the server 200 determines a resource for performing power balancing instead of the power supply lanes of the road R10 out of other resources managed by the aggregator (e.g., stationary energy storage devices, or power supply lanes of roads other than the road R10). Thereafter, in S302, the server 200 notifies the user terminal of the alternative resource of the start of power balancing, and then requests the alternative resource to perform the requested power balancing of the power grid PG. The requested power balancing of the power grid PG is thus performed by the alternative resource.

When step S302 of FIG. 11 is performed, the routine returns to the flowchart of FIG. 8, and the series of steps shown in FIG. 8 end. As described above, the server 200 (control device 250) is configured to perform vehicle selection (S55) when the number of vehicles traveling in the power supply lanes of the road R10 is equal to or larger than the predetermined value (YES in S52), and not to perform the vehicle selection when the number of vehicles traveling in the power supply lanes of the road R10 is less than the predetermined value (NO in S52). In the process shown in FIG. 8, the routine proceeds to S53 when the number N is equal to Th. However, the process may be modified so that the routine proceeds to S59 when the number N is equal to Th.

According to the power supply system having the configuration described above (see FIGS. 1 to 11), the balancing vehicles (vehicles for power balancing of the external power supply) can be selected from the vehicle group traveling in the power supply lanes so that the power supply lanes is likely to provide stable balancing power to the external power supply (power grid PG). The power balancing method according to the present embodiment includes the processes shown in FIGS. 6 to 11. In S101 of FIG. 9, the server 200 determines x and y. In S102 of FIG. 9, the server 200 selects the vehicles remaining after excluding the first x vehicles and the last y vehicles from the vehicle group traveling in the travel lanes (travel lanes R1, R2) equipped with the power supply equipment that is supplied with electric power from the power grid PG as selection candidates. The server 200 selects at least one of the selection candidates as balancing vehicles for power balancing of the power grid PG. In S56 of FIG. 8 (process shown in FIG. 10), the server 200 operates the balancing vehicles for power balancing of the external power supply (power grid PG). According to this method as well, the power supply lanes can easily provide stable balancing power to the external power supply (power grid PG).

In the above embodiment, the server 200 repeatedly performs update of x and y and vehicle selection during the balancing duration (see FIG. 8). However, the present disclosure is not limited to this, and the server 200 may perform update of x and y only at a predetermined timing in the balancing duration. In the above embodiment, the numbers x, y are changed according to the number N (number of vehicles 100 traveling in the power supply lanes) and the target balancing power (see S101 in FIG. 9). Therefore, the number of selection candidates also varies according to the numbers x, y. However, the present disclosure is not limited to this form, and the server 200 may determine the numbers x, y so that the number of selection candidates is fixed. For example, the control device 250 may be configured to switch between a normal mode (non-fixed number mode) and a fixed number mode. Switching of the operation mode (switching between the non-fixed number mode and the fixed number mode) may be performed according to an instruction from the user.

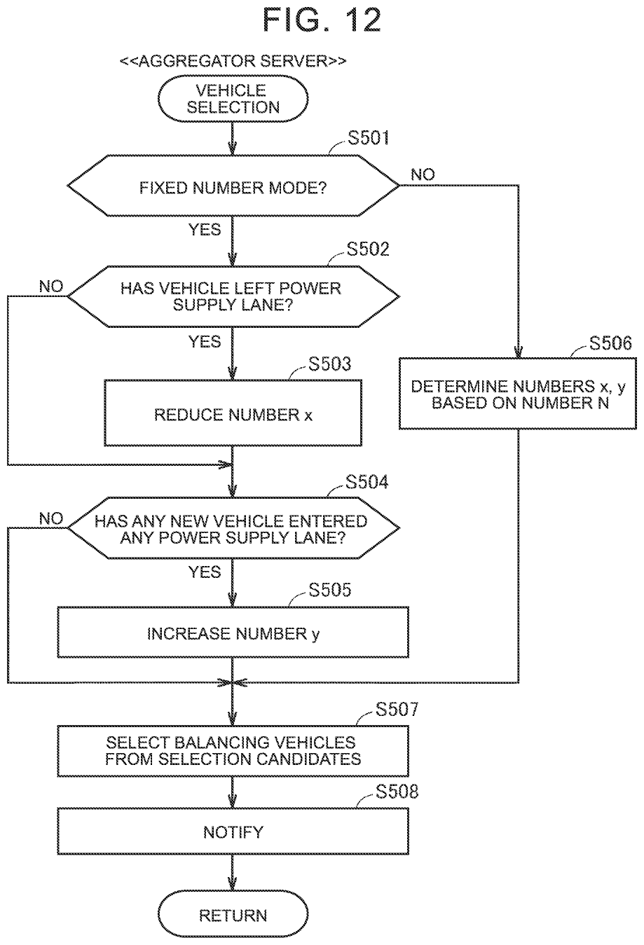

FIG. 12 is a flowchart of a first modification of the process shown in FIG. 9. In S55 of FIG. 8, the control device 250 of the server 200 may perform the process shown in FIG. 12 described below, instead of the process shown in FIG. 9.

Referring to FIG. 12 together with FIGS. 1, 2, and 5, in S501, the control device 250 determines whether the operation mode is the fixed number mode. When the operation mode is the non-fixed number mode (NO in S501), the control device 250 performs steps S506, S507, and S508 that are similar to S101, S102, and S103 of FIG. 9, respectively.

On the other hand, when the operation mode is the fixed number mode (YES in S501), the control device 250 determines in S502 whether the first vehicle 100 has left the power supply lane of the road R10. For example, in the case where the vehicle 100 that had been traveling in the power supply lane in the previous routine (hereinafter also referred to as “previous first vehicle”) has already passed the exit of the power supply lane in the current routine, the control device 250 determines that the previous first vehicle 100 has left the power supply lane of the road R10 (YES in S502). On the other hand, in the case where the previous first vehicle is still traveling in the power supply lane even in the current routine, the control device 250 determines that the previous first vehicle 100 has not left the power supply lane of the road R10 (NO in S502).

When YES in S502, the control device 250 reduces the number x by the same value as the number of vehicles 100 having left the power supply lanes in S503. The number of vehicles 100 having left the power supply lanes is counted based on the state in the previous routine. The control device 250 then proceeds to S504. On the other hand, when NO in S502, the control device 250 proceeds to S504 without changing the number x. As a result, the number x in the previous routine is maintained.

In S504, the control device 250 determines whether any new vehicle 100 has entered any power supply lane of the road R10. This determination is also made based on the state in the previous routine. When any new vehicle 100 has entered any power supply lane of the road R10 (YES in S504), the control device 250 increases the number y by the same number as the number of new vehicles 100 having entered the power supply lane(s) in S505. The number of new vehicles 100 having entered the power supply lane(s) is counted based on the state in the previous routine. Thereafter, the control device 250 performs steps S507 and S508 that are similar to S102 and S103 of FIG. 9. On the other hand, when no new vehicle 100 has entered any power supply lane of the road R10 (NO in S504), the control device 250 performs steps S507, S508 without changing the number y. As a result, the number y in the previous routine is maintained.

In the fixed number mode, the server 200 according to the first modification reduces x when the first vehicle 100 has left the power supply lane and increases y when any new vehicle 100 has entered any of the power supply lanes, in order for the number of selection candidates to be fixed. According to such a fixed number mode, a fixed number of vehicles 100 are selected as selection candidates. The power supply lanes can easily provide stable balancing power. Since the number of selection candidates does not change, the server 200 can easily perform vehicle selection and vehicle control.

In the fixed number mode, the server 200 according to the first modification updates x and y only at the exiting timing (timing the first vehicle leaves the power supply lane) and the entering timing (timing any new vehicle enters any of the power supply lanes). Since the timing of the update process is limited, the processing load on the server 200 is reduced.

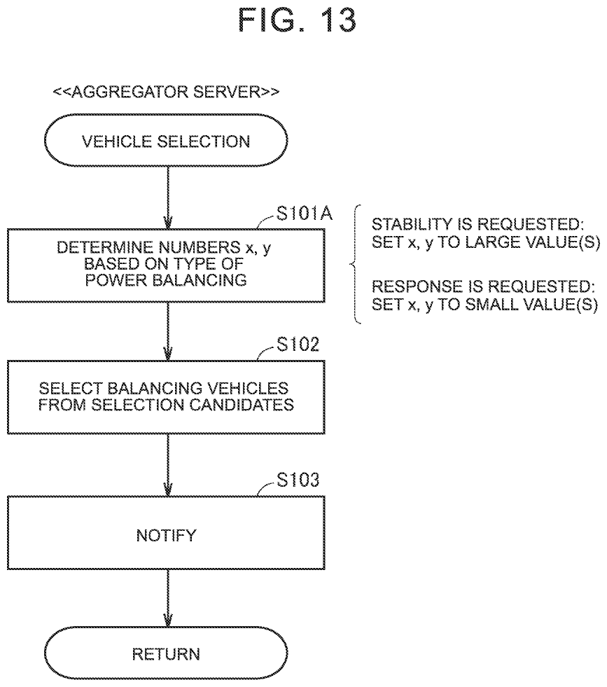

The server 200 may be configured to determine either or both of x and y based on the type of requested power balancing when power balancing of the power grid PG (external power supply) is requested. For example, in S55 of FIG. 8, the control device 250 of the server 200 may perform the process shown in FIG. 13 described below, instead of the process shown in FIG. 9. FIG. 13 is a flowchart of a second modification of the process shown in FIG. 9. The process shown in FIG. 13 is the same as the process shown in FIG. 9 except that the process shown in FIG. 13 includes step S101A instead of S101 (FIG. 9).

Referring to FIG. 13 together with FIGS. 1, 2, and 5, in S101A, the control device 250 determines the numbers x, y based on the type of requested power balancing. Specifically, the control device 250 sets the numbers x, y to larger values when stable balancing power (e.g., replacement reserve (RR), replacement reserve-for FIT (RR-FIT), or power source I′) is requested than when fast response balancing power (e.g., frequency containment reserve (FCR) or synchronized frequency restoration reserve (S-FRR)) is requested. For a balancing power request generated due to a successful bid on the electricity market, the control device 250 may determine the numbers x, y based on the product requirement. The control device 250 may determine that stable balancing power has been requested when the duration of the product requirement is longer than a predetermined time, and may determine that fast response has been requested when the response time of the product requirement is shorter than a predetermined time. The control device 250 may determine that fast response has been requested when a balancing power request is generated due to an imbalance regarding electricity balancing.

According to the server 200 of the second modification, the power supply lanes of the road R10 can easily provide the balancing power according to the request to the power grid PG (external power supply). In S101A of FIG. 13, x and y may be set to the same value. However, the present disclosure is not limited to this, and x and y may be set to different values, or may be determined based on different criteria.

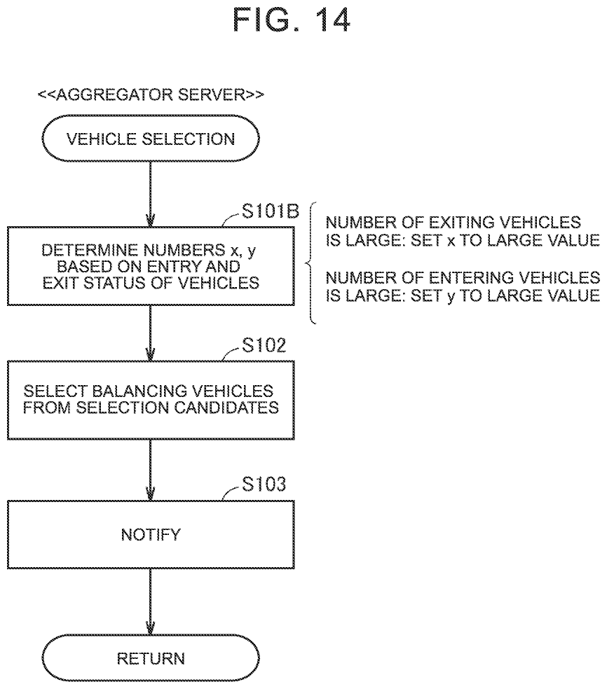

The server 200 may be configured to determine either or both of x and y based on the entry and exit status of the vehicles to and from the power supply lanes. For example, in S55 of FIG. 8, the control device 250 of the server 200 may perform the process shown in FIG. 14 described below, instead of the process shown in FIG. 9. FIG. 14 is a flowchart of a third modification of the process shown in FIG. 9. The process shown in FIG. 14 is the same as the process shown in FIG. 9 except that the process shown in FIG. 14 includes step S101B instead of S101 (FIG. 9).

Referring to FIG. 14 together with FIGS. 1, 2, and 5, in S101B, the control device 250 determines the numbers x, y based on the entry and exit status of the vehicles 100 to and from the power supply lanes (travel lanes R1, R2) of the road R10. Specifically, the control device 250 determines the numbers x, y by using the numbers of vehicles 100 entering and exiting the power supply lanes of the road R10 per unit time.

The control device 250 may increase the number x as the number of vehicles 100 leaving the power supply lanes of the road R10 per unit time increases. The number of vehicles 100 leaving the power supply lanes of the road R10 may be measured by a sensor or camera mounted near the exit of the power supply lanes. Alternatively, the control device 250 may determine the number x based on the vehicle speed of the vehicle 100 that is present near the exit of the power supply lanes. When the vehicle speed of the vehicle 100 that is present near the exit of the power supply lanes is low, the control device 250 may determine that there is a traffic congestion near the exit, and may estimate that the number of vehicles 100 leaving the power supply lanes of the road R10 per unit time will increase.

The control device 250 may increase the number y as the number of vehicles 100 entering the power supply lanes of the road R10 per unit time increases. The number of vehicles 100 entering the power supply lanes of the road R10 may be measured by a sensor or camera mounted near the entrance of the power supply lanes. Alternatively, the control device 250 may determine the number y based on the vehicle speed of the vehicle 100 that is present near the entrance of the power supply lanes. When the vehicle speed of the vehicle 100 that is present near the entrance of the power supply lanes is low, the control device 250 may determine that there is a traffic congestion near the entrance, and may estimate that the number of vehicles 100 entering the power supply lanes of the road R10 per unit time will increase.

According to the server 200 of the third modification, the power supply lanes of the road R10 can easily provide stable balancing power to the power grid PG (external power supply).

In a case in which the vehicle group VG managed by the vehicle management device 1000 includes vehicles promised to cooperate in power balancing by contract (virtual power plant (VPP) contract vehicles) and other vehicles (non-VPP contract vehicles), the vehicle management device 1000 may exclude the non-VPP contract vehicles from the processes shown in FIGS. 6 to 14.

Each vehicle 100 (FIG. 2) in the above embodiment includes an energy storage device configured to be charged with electric power from the travel lane of the road R10 on which the vehicle 100 is traveling. In the form in which the vehicle group VG managed by the vehicle management device 1000 includes vehicles not equipped with an energy storage device configured to be charged with electric power from the travel lane of the road R10 on which the vehicle is traveling (non-charging vehicles), the vehicle management device 1000 may exclude the non-charging vehicles from the processes shown in FIGS. 8 to 14 when charging for power balancing of the power grid PG (external power supply) is requested.

Each vehicle 100 (FIG. 2) in the above embodiment includes an energy storage device configured to discharge electric power to the power grid PG via the travel lane of the road R10 on which the vehicle 100 is traveling. In a case in which the vehicle group VG managed by the vehicle management device 1000 includes a vehicle (non-V2G vehicle) that does not have a power storage device configured to be able to discharge to the power grid PG via the traveling lane of the traveling road R10, the vehicle management device 1000 may exclude such a non-V2G vehicle from the processing target in the processing shown in FIGS. 8 to 14 when the discharge for power adjustment of the power grid PG is required.

The road to which the power supply system is applied is not limited to the road R10 shown in FIG. 5. The road to which the power supply system is applied may be a local road or an expressway. A gate through which only predetermined vehicles (e.g., managed vehicles or vehicles that have reserved the power supply equipment installed in the power supply lane) are allowed to pass may be installed at the entrance of the power supply lane of the road R10. The power supply lane (area where the power supply equipment is installed in the road) may have any desired length. For example, the length of the power supply lane may be 5 km or more and 100 km or less, or may be several kilometers. The road R10 shown in FIG. 5 has two power supply lanes and one no-power-supply lane. However, the road R10 may have more no-power-supply lanes than power supply lanes. The above power supply system may be applied to a road having one power supply lane or three or more power supply lanes, or a road having no no-power-supply lane.

The configuration of the system is not limited to the configuration shown in FIG. 1. Another server (e.g., a server of a higher-level aggregator) may be provided between the server 700 and the server 200. In the above embodiment, the servers 200, 500 are on-premises servers (see FIG. 1). However, the present disclosure is not limited to this, and the functions of the servers 200, 500 (particularly, the functions related to vehicle management) may be implemented in a cloud by cloud computing. At least a part of the functions of the server 500 may be implemented in the server 200.

The configuration of the managed vehicle is not limited to the configuration described in the above embodiment (see FIG. 2). The vehicle group VG may include a plurality of types of managed vehicles having different configurations. The configuration of the managed vehicle may be changed as appropriate to a configuration exclusively for manned driving or a configuration exclusively for unmanned driving. For example, a vehicle exclusively for unmanned driving need not necessarily include parts for a person to operate the vehicle (such as a steering wheel). The configuration of the managed vehicle is not necessarily limited to the configuration having an automated driving function.

The managed vehicle may be an xEV other than a BEV. The managed vehicle may be an xEV (hybrid electric vehicle, fuel cell electric vehicle, range extender EV, etc.) configured to be charged while traveling and/or discharged while traveling. The managed vehicle may be a hybrid electric vehicle including a hydrogen engine and an energy storage device. The managed vehicle may be equipped with a solar panel or may have a flight function. The managed vehicle is not limited to a passenger car, and may be a bus or a truck. The managed vehicle may be a personally owned vehicle (POV), or a mobility as a service (MaaS) vehicle. A MaaS vehicle is a vehicle managed by a MaaS service provider. The managed vehicle may be a multipurpose vehicle that is customized according to the user's purpose of use. The managed vehicle may be a mobile store vehicle, a robotaxi, an automated guided vehicle (AGV), or an agricultural machine. The managed vehicle may be an unmanned or one-seater small BEV (e.g., a Micro Pallet or an electric scooter).

The embodiment disclosed herein should be considered to be illustrative and not restrictive in all respects. The technical scope of the present disclosure is shown by the claims rather than by the above description of the embodiment, and is intended to include all modifications within the meaning and scope equivalent to the claims.

What is claimed is:

1. A power supply system, comprising:
power supply equipment configured to be supplied with electric power from an external power supply and supply the electric power to a vehicle traveling in a travel lane; and
a vehicle management device configured to manage vehicles configured to use the power supply equipment, and perform vehicle selection in which the vehicle management device selects a balancing vehicle for power balancing of the external power supply from the vehicles, wherein:
the vehicle management device is configured to (i) select vehicles remaining after excluding first x vehicles and last y vehicles from a vehicle group traveling in the travel lane as selection candidates and (ii) select at least one of the selection candidates as the balancing vehicle in the vehicle selection; and
each of the values x and y is an integer of 1 or more.

2. The power supply system according to claim 1, wherein the vehicle management device is configured to determine either or both of the value x and the value y using a number of vehicles traveling in the travel lane.

3. The power supply system according to claim 2, wherein the vehicle management device is configured to increase either or both of the value x and the value y as the number of vehicles traveling in the travel lane increases.

4. The power supply system according to claim 1, wherein the vehicle management device is configured to determine either or both of the value x and the value y based on an entry and exit status of the vehicles to and from the travel lane.

5. The power supply system according to claim 4, wherein the vehicle management device is configured to:
increase the value x as a number of vehicles leaving the travel lane per unit time increases; and
increase the value y as a number of vehicles entering the travel lane per unit time increases.

6. The power supply system according to claim 1, wherein the vehicle management device is configured to determine either or both of the value x and the value y based on a type of requested power balancing when power balancing of the external power supply is requested.

7. The power supply system according to claim 6, wherein the vehicle management device is configured to increase either or both of the value x and the value y as more stable balancing power is requested.

8. The power supply system according to claim 1, wherein the vehicle management device is configured to:
reduce the value x when a first vehicle has left the travel lane; and
increase the value y when a new vehicle has entered the travel lane such that a number of selection candidates is fixed.

9. The power supply system according to claim 1, wherein when power balancing of the external power supply for a predetermined balancing duration is requested, the vehicle management device performs update of the values x and y and the vehicle selection at least at a first timing a first vehicle leaves the travel lane and at a second timing a new vehicle enters the travel lane during the predetermined balancing duration.

10. The power supply system according to claim 1, wherein:
the vehicle management device performs the vehicle selection when a number of vehicles traveling in the travel lane is equal to or larger than a predetermined value; and
the vehicle management device does not perform the vehicle selection when a number of vehicles traveling in the travel lane is less than the predetermined value.

11. The power supply system according to claim 1, wherein the vehicle management device is configured to select the balancing vehicle from the selection candidates based on a magnitude of requested balancing power, when power balancing of the external power supply is requested.

12. The power supply system according to claim 11, wherein the vehicle management device is configured to select, as the balancing vehicle, a vehicle that is able to deal with a magnitude of the requested balancing power from the selection candidates based on at least one of a state of charge, rated charge power, and rated discharge power of an energy storage device of the vehicles of the selection candidates.

13. The power supply system according to claim 1, wherein the vehicle management device is configured to predict a number of vehicles that are going to be traveling in the travel lane during a predetermined period, and bid on balancing power for the predetermined period on an electricity market by using the predicted number of vehicles.

14. The power supply system according to claim 1, wherein:
each of the vehicles that is selected as the balancing vehicle when charging for power balancing of the external power supply is requested includes an energy storage device configured to be charged with electric power from the power supply equipment while the vehicle is traveling in the travel lane; and
the vehicle management device is configured to:
determine charge power for the balancing vehicle when charging for power balancing of the external power supply is requested; and
send a command to perform charging with the determined charge power to the balancing vehicle traveling in the travel lane.

15. The power supply system according to claim 1, wherein:
each of the vehicles that is selected as the balancing vehicle when discharging for power balancing of the external power supply is requested includes an energy storage device configured to discharge electric power to the external power supply via the power supply equipment while the vehicle is traveling in the travel lane; and
the vehicle management device is configured to:
determine discharge power for the balancing vehicle when discharging for power balancing of the external power supply is requested; and
send a command to perform discharging of the determined discharge power or stop charging to the balancing vehicle traveling in the travel lane.

16. A server for managing vehicles configured to use power supply equipment that is supplied with electric power from an external power supply and supply the electric power to a vehicle traveling in a travel lane, wherein:
the server is configured to perform vehicle selection in which the server selects a balancing vehicle for power balancing of the external power supply from the vehicles;
the server is configured to (i) select vehicles remaining after excluding first x vehicles and last y vehicles from a vehicle group traveling in the travel lane as selection candidates and (ii) select at least one of the selection candidates as the balancing vehicle in the vehicle selection; and
each of the values x and y is an integer of 1 or more.

17. A power balancing method, comprising:
determining x and y;
selecting, as selection candidates, vehicles remaining after excluding first x vehicles and last y vehicles from a vehicle group traveling in a travel lane equipped with power supply equipment that is supplied with electric power from an external power supply;
selecting at least one of the selection candidates as a balancing vehicle for power balancing of the external power supply; and
causing the balancing vehicle to operate for power balancing of the external power supply.
